(19) United States
(12) Patent Application Publication
(10) Pub. No.: US 2024/0254810 A1
(43) Pub. Date: Aug. 1, 2024

(54) ANTI-THEFT DEVICE FOR EYEGLASSES

(71) Applicant: Fasteners for Retail, Inc., Twinsburg, OH (US)

(72) Inventors: Bradley Reed Knox, Bardstown, KY (US); Alex L. Kuhl, Rockford, IL (US)

(73) Assignee: Fasteners for Retail, Inc., Twinsburg, OH (US)

(21) Appl. No.: 18/408,747

(22) Filed: Jan. 10, 2024

Related U.S. Application Data
(60) Provisional application No. 63/481,638, filed on Jan. 26, 2023.

(51) Int. Cl. E05B 73/00

(52) U.S. Cl. CPC E05B 73/00

(57) ABSTRACT

An anti-theft device includes a frame defining a channel extending from a first end to a second end and a first retention rail attached to the frame. Here, the first retention rail has a plurality of first retention members. The anti-theft device also includes a second retention rail slidably disposed in the channel and including a plurality of second retention members. The second retention members are operable to selectively engage the first retention members. The frame, the first retention members, and the second retention members cooperate to define a corresponding plurality of receptacles each operable to receive one or more eyeglasses.

### CROSS-REFERENCE TO RELATED APPLICATIONS

This application claims priority under 35 U.S.C. § 119(e) to U.S. Provisional Application 63/481,638, filed on Jan. 26, 2023. The disclosure of this prior application is considered part of the disclosure of this application and is hereby incorporated by reference in its entirety.

### FIELD

The present disclosure generally relates to anti-theft devices for eyeglasses.

### BACKGROUND

Retail theft is a multibillion-dollar problem facing retailers throughout the world. Retailers are constantly working to balance the need to make products accessible and presentable to prospective customers while at the same time ensuring that products are secured enough to deter or prevent theft of the products being displayed.

Accordingly, what is needed is an anti-theft device that allows retailers to display products in a secure, presentable, and assessable manner. However, in view of the art considered as a whole at the time the present disclosure was made, it was not obvious to those of ordinary skill in the field of this disclosure how the shortcomings of the prior art could be overcome.

The present disclosure may address one or more of the problems and deficiencies of the prior art discussed above. However, it is contemplated that the disclosure may provide useful in addressing other problems and deficiencies in a number of technical areas. Therefore, the present disclosure should not necessarily be construed as limited to addressing any of the particular problems or deficiencies discussed herein.

### SUMMARY

An aspect of the disclosure includes anti-theft device for storing eyeglasses. The anti-theft device includes a frame defining a channel extending from a first end to a second end, a first retention rail attached to the frame and including a plurality of first retention members, and a second retention rail slidably disposed in the channel and including a plurality of second retention members, the second retention members operable to selectively engage the first retention members, wherein the frame, the first retention members, and the second retention members cooperate to define a corresponding plurality of receptacles each operable to receive one or more of the eyeglasses.

Aspects of the disclosure may include one or more of the following optional features. In some examples, the second retention rail is operable to translate within the channel along the translation axis between an open configuration to permit access to the receptacle and a closed configuration to prevent access to the receptacle. In some implementations, each of the first retention members includes a first support extending away from the first body and a first overhang extending away from the first support in a first direction, and each of the second retention members includes a second support extending away from the second body and a second overhang extending away from the second support in a second direction opposite the first direction.

In some implementations, at least a portion of each first overhang is disposed adjacent to at least a portion of a corresponding second overhang in the closed configuration, and each first overhang is spaced apart from each corresponding second overhang in the open configuration.

In some examples, the channel comprises a notch operable to receive a portion of the second retention rail in the open configuration. In some configurations, the retention mechanism further comprises a locking mechanism operable to prevent the second retention rail from translating from the closed configuration to the open configuration.

Another aspect of the disclosure provides an anti-theft device for storing eyeglasses. The anti-theft device includes a base having a first end and a second end, the first end opposite the second end, a first support member coupled to the first end of the base and including a first receiving portion, a second support member coupled to the second end of the base and including a second receiving portion, and a retention rod extending from the first receiving portion to the second receiving portion and configured to translate between an open configuration and a closed configuration to selectively permit access to the base.

Aspects of the disclosure may include one or more of the following optional features. In some examples, the retention mechanism includes a frame extending from the first end to the second end of the base, the frame operable to receive at least a bridge or nose pad of the eyeglasses. Optionally, in the closed configuration, the retention rod is positioned vertically above the frame. In some examples, in the open configuration, the retention rod is laterally offset from the frame. In some examples, in the closed configuration, a distance between the retention rod and the frame is configured to be less than a height of a lens of a pair of eyeglasses.

In some configurations, the retention rod is capable of moving within the first receiving portion and the second receiving portion to operate between the closed configuration and the open configuration. In some implementations, the retention rod includes a proximal end, a distal end, a first end cap attached to the proximal end, and a second end cap attached to the distal end, wherein the first end cap secures the proximal end of the retention rod within the first receiving portion and the second end cap secures the distal end of the retention rod within the second receiving portion.

In some configurations, the retention mechanism further includes a locking mechanism attached to the second support member, the locking mechanism includes an opening that surrounds a portion of the second receiving portion, wherein the locking mechanism is configured to mechanically engage the second end cap of the retention rod to secure the retention rod in the closed configuration.

Another aspect of the disclosure provides an anti-theft device for storing eyeglasses. The anti-theft device comprising one or more retention members each including a retention base, a cradle attached to the retention base, a retention hook rotatably attached to the cradle, wherein the cradle and the retention hook cooperate to define a receptacle operable to receive one or more of the eyeglasses.

Aspects of the disclosure may include one or more of the following optional features. In some implementations, each retention hook is operable to rotate between an open configuration to permit access to the receptacle and a closed configuration to prevent access to the receptacle. In some examples, each cradle comprises a first arm having a socket at a distal end of the first arm and a second arm having a distal end. In some implementations, each retention hook comprises a first end and a second end, wherein the first end of the retention hook is rotatably attached to the distal end of the second arm. In some configurations, the second end of the retention hook interfaces with the socket at the distal end of the first arm in the closed configuration. Optionally, each retention member further comprises a biasing feature biasing the retention hook in a closed configuration.

### DRAWINGS

The drawings described herein are for illustrative purposes only of selected configurations and not all possible implementations, and are not intended to limit the scope of the present disclosure.

FIG. 1 depicts a front perspective view of an example anti-theft device in a closed configuration and including multiple eyeglasses, according to a first aspect of the present disclosure.

FIG. 2 depicts a front perspective view of the anti-theft device of FIG. 1 in an open configuration and including multiple eyeglasses.

FIG. 3 depicts a front perspective view of the anti-theft device of FIG. 1 in the closed configuration.

FIG. 4 depicts a front perspective view of the anti-theft device of FIG. 1 in the open configuration.

FIG. 5 depicts a left side view of the anti-theft device in the open configuration.

FIG. 6 depicts a right side view of the anti-theft device of FIG. 1 in the open configuration.

FIG. 7 depicts a left side view of the anti-theft device of FIG. 1 in the closed configuration.

FIG. 8 depicts a right side view of the anti-theft device of FIG. 1 in the closed configuration.

FIG. 9 depicts a rear perspective view of the anti-theft device of FIG. 1 operating from the closed configuration to the open configuration.

FIG. 10 depicts a perspective view of an example anti-theft device in a closed configuration and including multiple eyeglasses, according to a second aspect of the present disclosure.

FIG. 11 depicts a perspective view of the anti-theft device of FIG. 10 in an open configuration and including multiple eyeglasses.

FIG. 12 depicts a perspective view of the anti-theft device of FIG. 10 in the closed configuration.

FIG. 13 depicts a perspective view of the anti-theft device of FIG. 10 in the open configuration.

FIG. 14 depicts a rear view of the anti-theft device of FIG. 10 in the closed configuration.

FIG. 15 depicts a rear view of an example anti-theft device of FIG. 10 in the open configuration.

FIG. 16 depicts a perspective view of an example anti-theft device including multiple eyeglasses, according to a third aspect of the present disclosure.

FIG. 17 depicts a perspective view of the anti-theft device of FIG. 16.

FIG. 18 depicts a front view of a single retention mechanism of the anti-theft device of FIG. 16.

FIG. 19 depicts a rear view of the single retention mechanism of FIG. 18.

FIG. 20 depicts a right-side view of the single retention mechanism of FIG. 18.

FIG. 21 depicts a left-side view of the single retention mechanism of FIG. 18

FIG. 22 depicts a perspective view of an example anti-theft device including multiple eyeglasses, according to another aspect of the present disclosure.

FIG. 23 depicts a perspective view of the anti-theft device.

FIG. 24 depicts a front view of a single retention mechanism of the anti-theft device of FIG. 22.

FIG. 25 depicts a rear view of the single retention mechanism of the anti-theft device of FIG. 24.

FIG. 26 depicts a right-side view of the single retention mechanism of the anti-theft device of FIG. 24.

FIG. 27 depicts a left-side view of the single retention mechanism of the anti-theft device of FIG. 24.

FIG. 28 depicts a perspective view of an example anti-theft device including multiple eyeglasses, according to another aspect of the present disclosure.

FIG. 29 depicts a perspective view of a single retention display case with a retention door opening, according to another aspect of the present disclosure.

FIG. 30 depicts a perspective view of the single retention display case of FIG. 29 with the retention door closing.

FIG. 31 depicts a perspective view of an example anti-theft device including multiple eyeglasses, according to another aspect of the present disclosure.

FIG. 32 depicts a perspective view of a single retention display case stack with a retention door opening, according to another aspect of the present disclosure.

FIG. 33 depicts a perspective view of the single retention display case of FIG. 32 with a retention door closing.

FIG. 34 depicts an enlarged view of a locking mechanism of the anti-theft device of FIG. 32.

FIG. 35 depicts a front perspective view of an example anti-theft device in a closed configuration and including multiple eyeglasses, according to a seventh aspect of the present disclosure.

FIG. 36 depicts a front perspective view of the anti-theft device of FIG. 35 in an open configuration and including multiple eyeglasses.

FIG. 37 depicts a front perspective view of an example anti-theft device in a closed configuration and including multiple eyeglasses, according to another aspect of the present disclosure.

FIG. 38 depicts a front perspective view of the anti-theft device of FIG. 37 in an open configuration and including multiple eyeglasses.

FIG. 39 depicts a front perspective view of the anti-theft device of FIG. 37 in the closed configuration.

FIG. 40 depicts a rear perspective view of the anti-theft device of FIG. 37 in the closed configuration.

FIG. 41 depicts a perspective view of an example anti-theft device including multiple eyeglasses, according to another aspect of the present disclosure.

FIG. 42 depicts a perspective view of the anti-theft device of FIG. 41 including multiple eyeglasses with a retention container being removed therefrom.

FIG. 43 depicts a front perspective view of an example anti-theft device in a closed configuration and including multiple eyeglasses, according to another aspect of the present disclosure.

FIG. 44 depicts a front perspective view of the anti-theft device of FIG. 43 in an open configuration.

FIG. 45 depicts a front view of a single retention mechanism of the example anti-theft device of FIG. 43 in the closed configuration.

FIG. 46 depicts a rear view of the single retention mechanism of the anti-theft device of FIG. 43 in the closed configuration.

FIG. 47 depicts a left-side view of the single retention mechanism of the anti-theft device of FIG. 43 in the closed configuration.

FIG. 48 depicts a left-side view of the single retention mechanism of the anti-theft device of FIG. 43 in the open configuration.

FIG. 49 depicts a perspective exploded view of the single retention mechanism of the anti-theft device of FIG. 44 in the closed configuration.

FIG. 50 depicts a front view of an example single retention mechanism in the closed configuration, according to another aspect of the present disclosure.

FIG. 51 depicts a rear view of the example single retention mechanism of FIG. 50 in the closed configuration.

FIG. 52 depicts a left-side view of the example single retention mechanism of FIG. 50 in the closed configuration.

FIG. 53 depicts a perspective exploded view of the example single retention mechanism of FIG. 50 in the closed configuration.

FIG. 54 depicts a front view of an example single retention mechanism in the closed configuration, according to another aspect of the present disclosure.

FIG. 55 depicts a rear view of the example single retention mechanism of FIG. 54 in the closed configuration.

FIG. 56 depicts a left-side view of the example single retention mechanism of FIG. 54 in the closed configuration.

FIG. 57 depicts a perspective exploded view of the example single retention mechanism of FIG. 54 in the closed configuration.

FIG. 58 depicts a front view of an example single retention mechanism in the closed configuration, according to another aspect of the present disclosure.

FIG. 59 depicts a rear view of the example single retention mechanism of FIG. 58 in the closed configuration.

FIG. 60 depicts a left-side view of the example single retention mechanism of FIG. 58 in the closed configuration.

FIG. 61 depicts a perspective exploded view of the example single retention mechanism of FIG. 58 in the closed configuration.

FIG. 62 depicts an example process flow diagram depicting the steps of an exemplary method of securing an article of manufacture within the anti-theft device.

### DETAILED DESCRIPTION

Multiple different examples are described herein for an anti-theft device that displays articles of manufacture (i.e., eyeglasses) and prevents theft of the displayed articles of manufacture. Advantageously, the multiple examples of the anti-theft device enable retailers to display eyeglasses to customers and prevent the eyeglasses from being shoplifted by the customers. The eyeglasses may include, but are not limited to, sunglasses and prescription glasses. The aspects herein describe the anti-theft device displaying eyeglasses, however, it is understood that the anti-theft device may display any other article of manufacture. As will become apparent, the anti-theft devices include a closed configuration that prevents or inhibits removal of eyeglasses from within the anti-theft devices and an open configuration that enables removal of the eyeglasses from within the anti-theft devices and/or placing of the eyeglasses within the anti-theft-device.

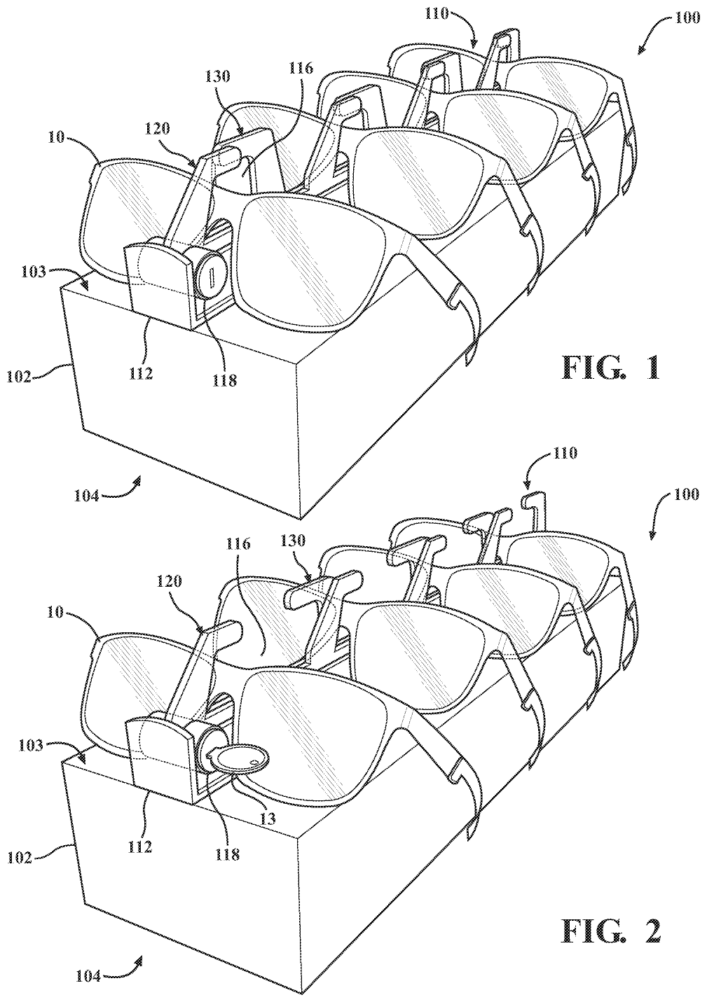

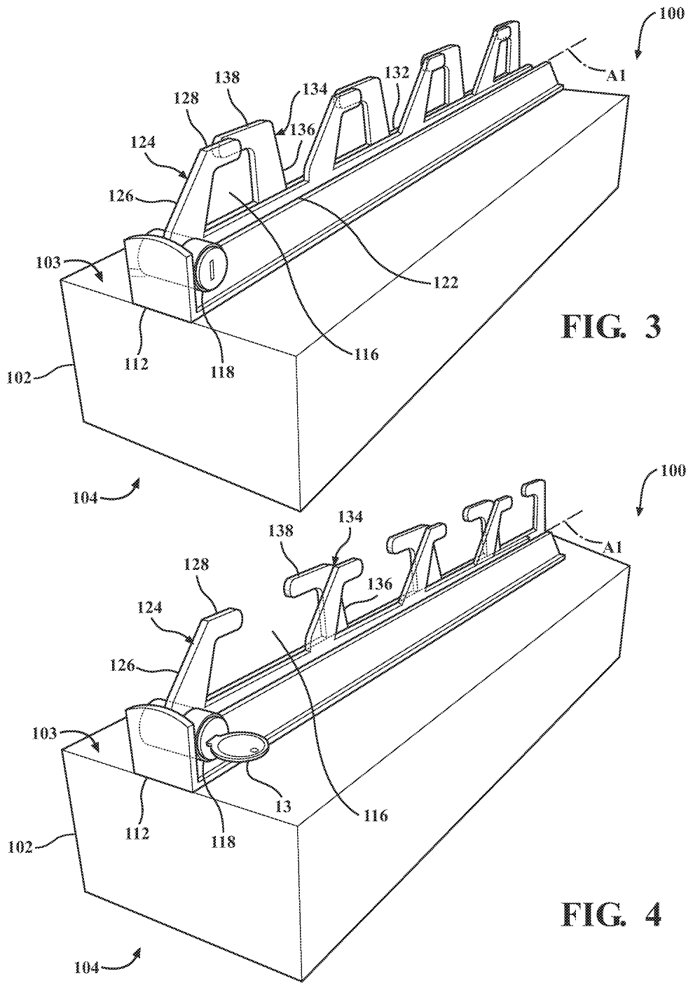

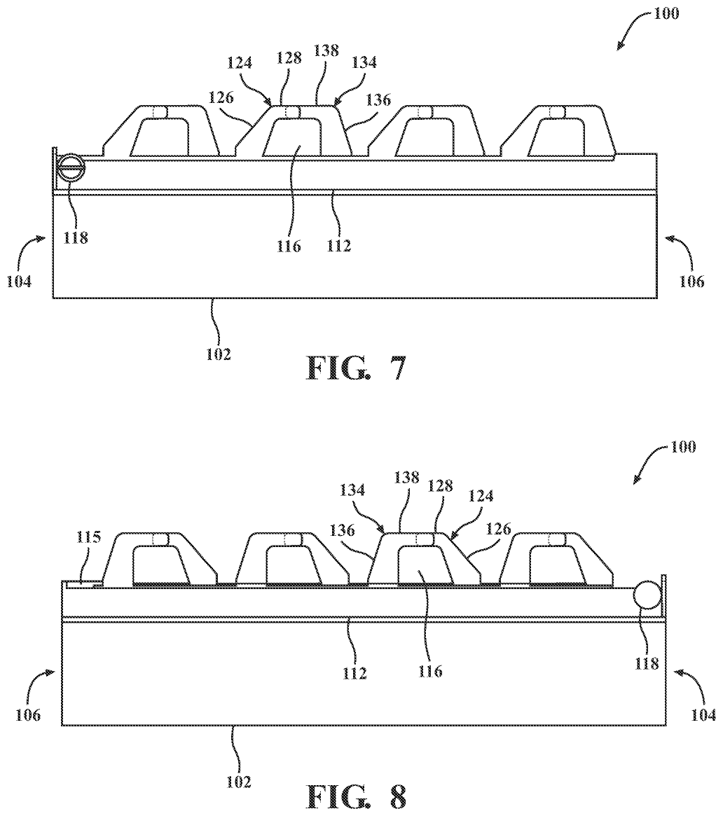

FIGS. 1-9 depict a first example of an anti-theft device 100 including a base 102 and a retention mechanism 110 coupled to a portion of the base 102. The base 102 includes a support surface 103 such that the retention mechanism 110 is disposed on the support surface 103 of the base 102. The base 102 may be any structure that is capable of being secured to the retention mechanism 110 to prevent the theft of an article of manufacture, such as eyeglasses 10, on display. Moreover, the base 102 includes a first end 104 and a second end 106 where the first end 104 is opposite the second end 106. The retention mechanism 110 includes a frame 112 extending from the first end 104 to the second end 106. The frame 112 includes a first retention rail 120 and a second retention rail 130. In some examples, the frame 112 defines a channel 114 extending from the first end 104 to the second end 106 of the base 102. The channel 114 is operable to receive at least a portion of the first retention rail 120 and a portion of the second retention rail 130. The frame 112 is configured to receive and support at least a bridge or a nose pad of the eyeglasses 10.

The first retention rail 120 includes a first body 122 having a first plurality of retention members 124, and the second retention rail 130 includes a second body 132 having a second plurality of retention members 134. In the example shown, the first plurality of retention members 124 and the second plurality of retention members 134 each include four respective retention members for the sake of clarity only, as it is understood that the first plurality of retention members 124 and the second plurality of retention members 134 may include any number of retention members. The first plurality of retention members 124 are operable to selectively interface with the second plurality of retention members 134 to secure the eyeglasses 10 within the retention mechanism 110. That is, when the first plurality of retention members 124 interface with the second plurality of retention members 134, the eyeglasses 10 cannot be removed from the retention mechanism 110. Described in greater detail below, each retention member 124 of the first plurality of retention members 124 interfaces a corresponding one of the retention members 134 of the second plurality of retention members 134 in a closed configuration (as shown in FIGS. 1, 3, 7, and 8) and, conversely, each retention member 124 of first plurality of retention members 124 is disengaged from the corresponding one of the retention members 134 of the second plurality of retention members 134 in the open configuration (as shown in FIGS. 2, 4, 5, 6)

The frame 112, the first plurality of retention members 124, and the second plurality of retention members 134 cooperate to define a corresponding plurality of receptacles 116 each operable to receive one or more of the eyeglasses 10. That is, each one of the first plurality of retention members 124 is associated with a corresponding one of the second plurality of retention members 134 defining a respective receptacle 116. As such, because the first plurality of retention members 124 and the second plurality of retention members 134 each include four retention members in the example shown, the retention mechanism 110 includes a corresponding four receptacles 116 each operable to receive one or more eyeglasses 10. In the closed configuration, each receptacle 116 defined by the frame 112, the first plurality of retention members 124, and the second plurality of retention members 134 is closed such that the eyeglasses 10 may not be provided (i.e., inserted) into the closed area 116 or removed from the closed area 116. In the open configuration, each receptacle 116 defined by the frame 112, the first plurality of retention members 124, and the second plurality of retention members 134 is open such that the eyeglasses 10 may be provided within the open area 116 or removed from within the open area 116.

Each retention member 124 of the first plurality of retention members 124 includes a first support 126 extending away from the first body 122 and a first overhang 128 attached to the first support 126. Here, each first overhang 128 extends away from the first support 126 in a first direction. That is, the first overhang 128 may extend away from the first support 126 and towards the second end 106 of the base 102. Moreover, each retention member 134 of the second plurality of retention members 134 includes a second support 136 extending away from the second body 132 and a second overhang 138 attached to the second support 136. Here, each second overhang 138 extends away from the second support 136 in a second direction opposite the first direction. That is, the second overhang 138 may extend away from the second support 136 and towards the first end 104 of the base 102 (i.e., opposite the second end 106 of the base 102).

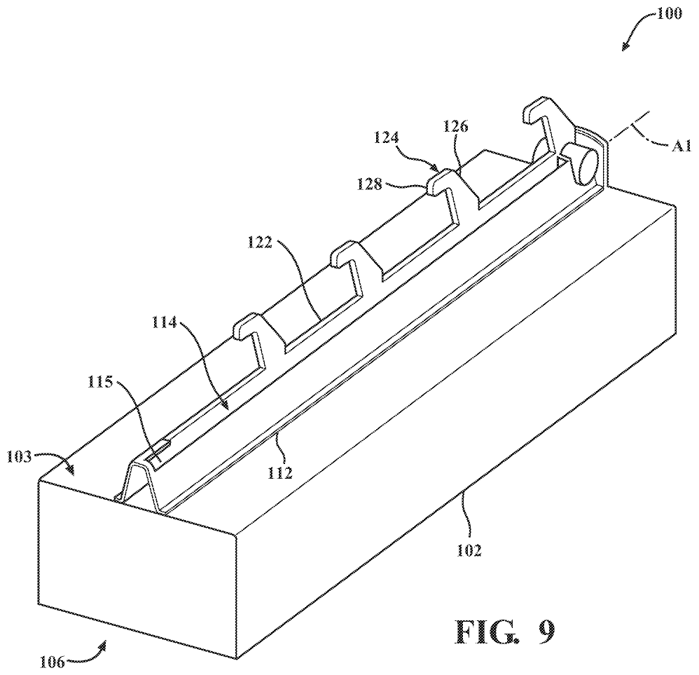

As shown in FIG. 9, the first retention rail 120 is fixed to the frame 112 and the second retention rail 130 is removed from channel 114 of the frame 112. The frame 112 and the channel 114 extend along a translation axis A1 that extends from the first end 104 to the second end 106 of the base 102. When assembled, the first retention rail 120 and the second retention rail 130 are disposed adjacent to one another in a direction transverse to the translation axis A1 (i.e., a lateral direction). In yet other examples, the first retention rail 120 is coupled with or formed integrally with the frame 112, such that the first retention rail 120 is secured in a fixed position (i.e., the frame 112 cannot move relative to the frame 112).

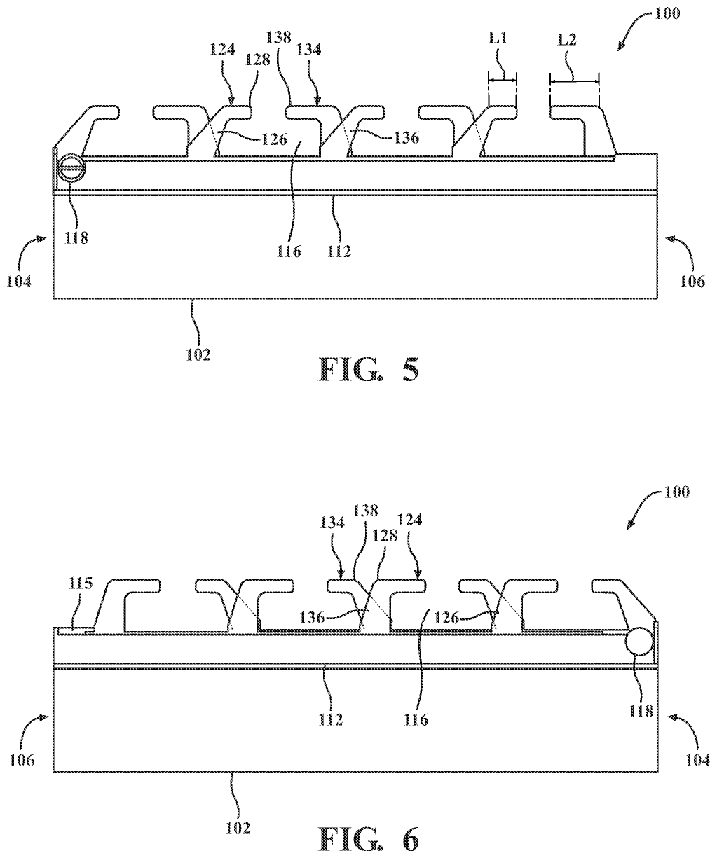

Referring to FIGS. 5-8, the second retention rail 130 is operable to translate with respect to the frame 112 and/or the first retention rail 120 within the channel 114 along the translation axis A1 that extends from the first end 104 to the second end 106 of the base 102. As such, translating the second retention rail 130 within the channel 114 along the translation axis A1 operates the retention mechanism 110 between the closed configuration and the open configuration. More specifically, the channel 114 may include a notch 115 located near the second end 106 of the base, which is operable to receive an end portion of the second retention rail 130 when the second retention rail 130 is in the open configuration. When the second retention rail 130 is in the closed configuration, the second retention rail 130 may withdrawn from the notch 115. In short, the notch 115 enables the second retention rail 130 to translate within the channel 114 along the translation axis A1 between the open configuration and the closed configuration.

The channel 114 is operable to guide the second retention rail 130 as the second retention rail 130 translates between the closed configuration and the open configuration and the notch 115 provides a void within the channel 114 such that the second retention rail 130 may translate from the closed configuration to the open configuration. In contrast, the channel 114 does not include a notch operable to receive a portion of the first retention rail 120, and thus, the first retention rail 120 is unable to translate along the direction of the axis A1 within the channel 114. The channel 114 may include a stop operable to restrict the movement of the second retention rail 130 when the second retention rail 130 reaches the closed configuration or the open configuration. Optionally, the channel 114 may include one or more additional stops configured to incrementally restrict the movement of the second retention rail 130 at various positions along the channel 114, thereby allowing the retention mechanism 110 to secure eyeglasses 10 of various dimensions and geometric shapes.

When in the closed configuration, at least a portion of each first overhang 128 of the first plurality of retention members 124 is disposed adjacent to and overlapping at least a portion of each second overhang 138 of the second plurality of retention members 134. The overlapping of the first overhangs 128 and the second overhangs 138 prevents the eyeglasses 10 from being removed from, or placed within, the defined receptacles 116 of the retention mechanism 110. Stated differently, at least a portion of the first overhangs 128 overlap (or partially overlap) at least a portion of a corresponding one of the second overhangs 138 to selectively obstruct a passageway into each receptacle 116. Thus, each first retention member 124 (including the first overhang 128) may be associated with a corresponding one of the second plurality retention of members 134 (including the second overhang 138). When in the open configuration, each of the first overhangs 128 of the first plurality of retention members 124 are spaced apart (e.g., spaced apart by a predetermined distance) from the second overhangs 138 of the second plurality of retention members 134 to define the passageway, such that the eyeglasses 10 may be removed from, or placed within, one of the areas 116 of the retention mechanism 110. In some examples, the first plurality of retention members 124 and the second plurality of retention members 134 are identical. In other examples, the first plurality of retention members 124 and the second plurality of retention members 134 have different geometric shapes and/or sizes from one another depending on a shape of the eyeglasses 10 secured within the retention mechanism 110.

The first support 126 extends vertically away from the first body 122 in the first direction and the second support 136 extends vertically away from the second body 132 in the second direction. Here, the first and second direction may be transverse to the translation axis A1. For example, the first direction may define a perpendicular angular, an acute angle, or an obtuse angle between the first direction and the translation axis A1. Similarly, the second direction may define a perpendicular angle, an acute angle, or an obtuse angle between the second direction and the translation axis A1. Moreover, the first overhang 128 may attach to a distal end of the first support 126 and extend away from the first support 126 towards the second end 106 of the base 102 in a third direction parallel to and substantially above a top surface of the frame 112. The first overhang 128 may extend from the first support 126 at an obtuse angle relative to a longitudinal axis of the first support 126 (e.g., an axis extending from a first end of the first support 126 attached to the first body 122 to the distal end attached to the first overhang 128). The second overhang 138 may attach to the second support 136 and extends away from the second support 136 towards the first end 104 of the based in a fourth direction parallel to and substantially above the translation axis A1. The second overhang 138 may extend from the distal end of the second support 136 at a substantially perpendicular angle relative to a longitudinal axis of the second support. The first overhang 128 includes a first length L1 and the second overhang includes a second length L2. Here, the first length L1 is greater than the second length L2.

In some examples, the retention mechanism 110 includes a locking mechanism 118 coupled to the frame 112 and/or the first retention rail 120. Moreover, the locking mechanism 118 may selectively engage the second retention rail 130. That is, the locking mechanism 118 is configured to mechanically engage the second retention rail 130 thereby securing the second retention rail 130 in the closed configuration to the frame 112 and/or the first retention rail 120. As the locking mechanism 118 mechanically engages the second retention rail 130, the locking mechanism 118 prevents the second retention rail 130 from translating from the closed configuration to the open configuration. The locking mechanism 118 may secure the second retention rail 130 to the first retention rail 120 (i.e., fixed retention rail) and/or the frame 112. The locking mechanism 118 may be any mechanism known in the art to prevent the movement of the second retention rail 130, such as a deadbolt, mortise cylinder, rim cylinder, key-in-knob cylinder, cam locks, interchangeable core cylinders, euro profile cylinders, disk tumbler lock, press fit, or an electronic or electro-mechanical lock. A key 13 may be operable to mechanically engage (or disengage) the locking mechanism 118 to the second retention rail 130.

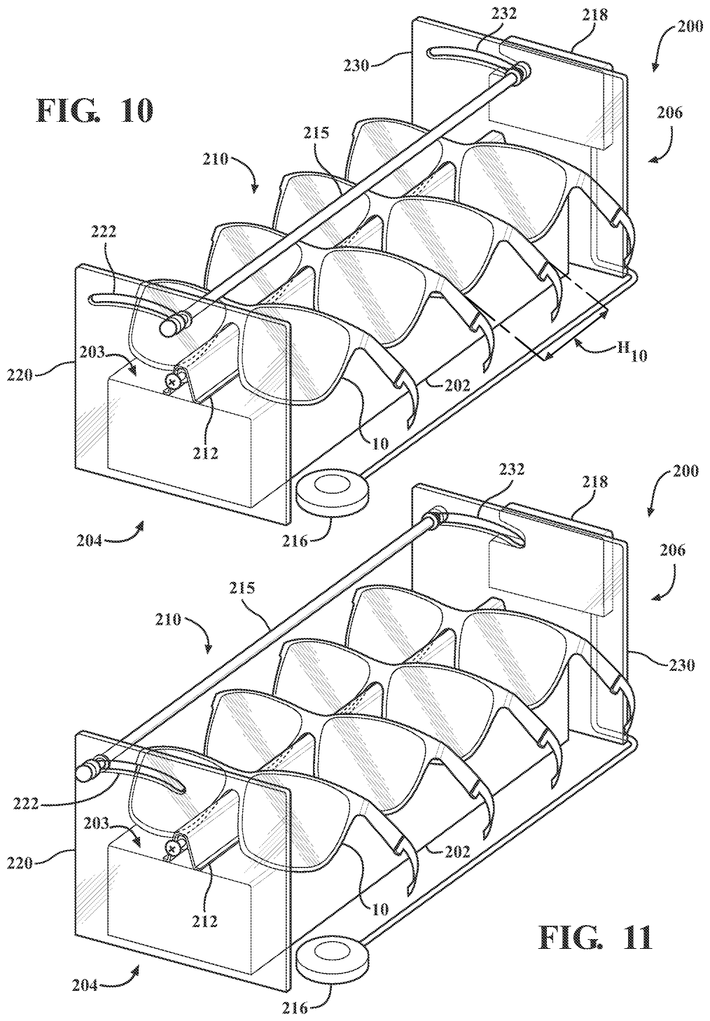

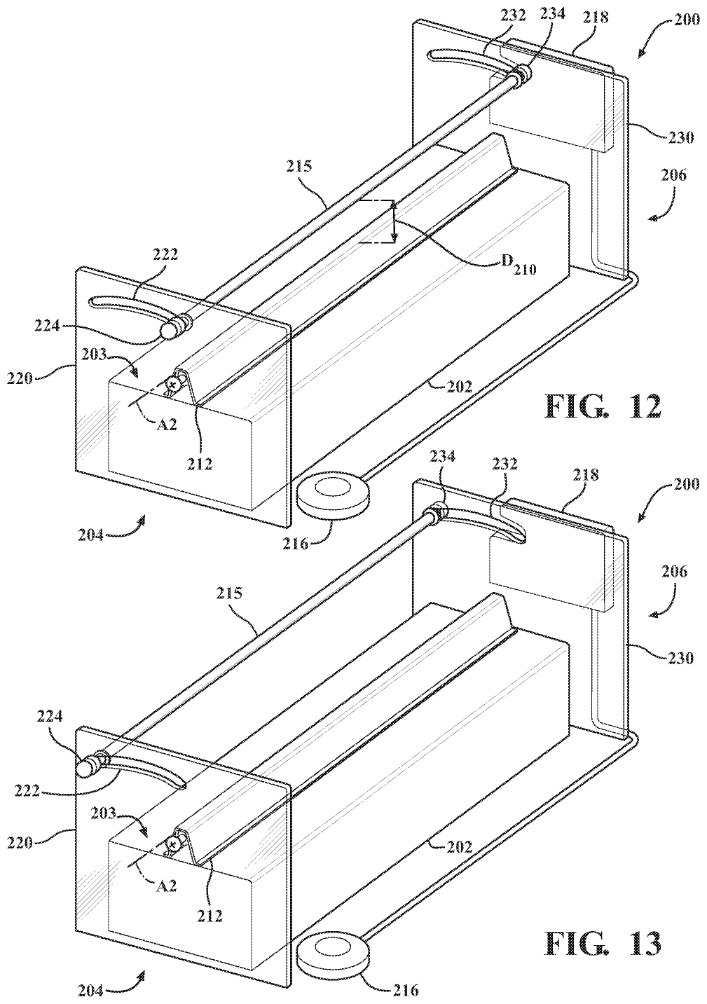

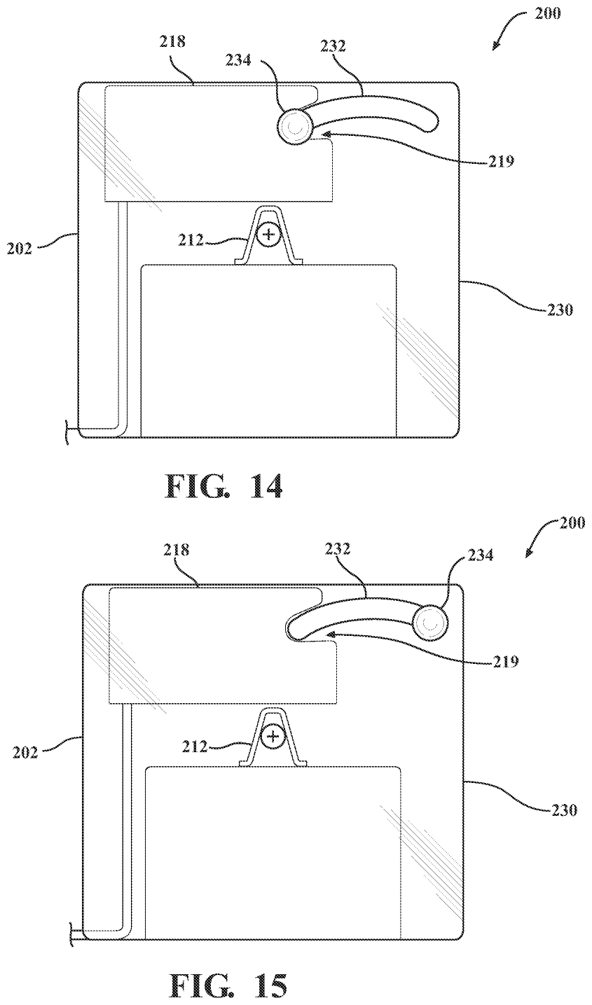

FIGS. 10-15 depict another example of an anti-theft device 200 including a base 202, and a retention mechanism 210 coupled to a portion of the base 202. The base 202 includes a support surface 203 such that the retention mechanism 210 is disposed on the support surface 203 of the base 202. The base 202 may be any structure that is capable of being secured to the retention mechanism 210 to prevent the theft of eyeglasses 10 on display. Moreover, the base 202 includes a first end 204 and a second end 206 where the first end 204 is opposite the second end 206. The retention mechanism 210 includes a frame 212 attached to the support surface 203 of the base 202 and extending from the first end 204 to the second end 206 along a second axis A2. The frame 212 is configured to receive and support at least a bridge or a nose pad of the eyeglasses 10 on display.

The retention mechanism 210 is configured to secure the eyeglasses 10 within the anti-theft device 200. The retention mechanism 210 includes a retention rod 215, a first retention member 220, and a second retention member 230. The first retention member 220 is coupled to the first end 204 of the base 202 and the second retention member 230 is coupled to the second end 206 of the base 202. In some examples, the first retention member 220 and the second retention member 230 include a transparent material such that a customer can see through the first retention member 220 and the second retention member 230. The first retention member 220 includes a first receiving portion 222 and the second retention member 230 includes a second receiving portion 232. In some examples, the first receiving portion 222 includes a first slot 222 and the second receiving portion 232 includes a second slot 232 that mirrors the first slot 222 from the first receiving portion 222. The slots 222, 232 may include a curved slot (as shown in FIGS. 10-15) or a straight slot (not shown). For example, each of the slots 222, 232 may have an arcuate curvature that is concave with respect to the support surface 203 of the base 202 (i.e., the concavity faces the base 202). Discussed in greater detail below, the first receiving portion 222 and the second receiving portion 232 are operable to receive the retention rod 215.

The retention rod 215 includes a first end cap 224 attached to a proximal end of the retention rod 215 and a second end cap 234 attached to a distal end of the retention rod 215. The retention rod 215 extends from the first receiving portion 222 to the second receiving portion 232. In particular, the first receiving portion 222 and the second receiving portion 232 are operable to receive the proximal end and distal end of the retention rod 215 whereby the first end cap 224 operably secures the retention rod 215 within the first receiving portion 222 and the second end cap 234 secures the retention rod 215 within the second receiving portion 232. That is, the first end cap 224 and the second end cap 234 secure the retention rod 215 within the first receiving portion 222 and the second receiving portion 232, respectively, such that the retention rod 215 cannot be removed from the retention mechanism 210. For example, each of the end caps 224, 234 may include a groove or retainer that receives a portion of the respective retention member 220, 230 to restrict movement of the retention rod 215 along a longitudinal direction.

The retention rod 215 is operable to translate with respect to the base 202 between a closed configuration and an open configuration. As shown in FIGS. 10, 12, and 14, the retention rod 215 is in the closed configuration such that the retention rod 215 is aligned above the frame 212. That is, in the closed configuration, the retention rod 215 is vertically aligned directly above (or substantially above) the frame 212 such that the retention rod 215 prevents eyeglasses 10 from being removed from, or placed within, the retention mechanism 210. More specifically, in the closed configuration a distance between the frame 212 and the retention rod 215 is defined such that the retention mechanism 210 prevents the eyeglasses 10 from being removed from, or placed within, the retention mechanism 210. Stated differently, the distance D₂₁₀ between the frame 212 and the retention rod 215 in the closed configuration is smaller than a height H₁₀ of the lens portions of the eyeglasses 10 thereby preventing the eyeglasses 10 from being lifted from the frame 212 and removed. Thus, translating the retention rod 215 between the open configuration and the closed configured selectively permits access to the frame 212 and the base 202.

The retention rod 215 is operable to translate between the closed configuration and the open configuration. That is, the retention rod 215 moves within the first receiving portion 222 and the second receiving portion 232 such that the retention rod 215 operates between the closed configuration and the open configuration. As shown in FIGS. 11, 13, and 15, the retention rod 215 is in the open configuration such that the retention rod 215 is not aligned vertically above the frame 212. That is, in the open configuration, the retention rod 215 of offset in a lateral direction (e.g., right or left relative to the axis A2) from the frame 212 the distance between the frame 212 and the retention rod 215 is defined such that the retention mechanism 210 allows the eyeglasses 10 to be placed within, or removed from, the retention mechanism 210. Stated differently, the retention rod 215 is offset from the frame 212 in the open configuration such that the area or space above the frame 212 is unobstructed by the retention rod 215, thereby allowing the eyeglasses 10 to be lifted from the frame 212 and removed.

In some examples, the retention mechanism 210 includes a locking mechanism 218 coupled to the retention mechanism 210. In the example shown, the locking mechanism 218 is coupled to the second retention member 230, however, the locking mechanism 218 may be coupled to the first retention member 220 in addition to (e.g., another retention member), or in lieu of, the locking mechanism 218 being coupled to the second retention member 230. The locking mechanism 218 includes an opening 219 that surrounds an end portion of the second receiving portion 232. As such, the locking mechanism 218 is configured to mechanically engage the retention rod 215. That is, the opening 219 of the locking mechanism 218 may mechanically engage the second end cap 234 or any portion of the retention rod 215 when the retention rod 215 is in the closed configuration thereby securing the retention rod 215 in the closed configuration. As such, when the locking mechanism 218 engages the retention rod 215, the locking mechanism 218 prevents the retention rod 215 from translating from the closed configuration to the open configuration such that the eyeglasses 10 are effectively closed within the retention mechanism 210 because the retention rod 215 is secured in the closed configuration.

In some examples, the locking mechanism 218 includes a lock controller 216 in communication with the locking mechanism 218. The lock controller 216 may be attached to the base 202 and/or to any portion of the retention mechanism 210. In some examples, the lock controller 216 is electrically coupled to the locking mechanism 218 or wirelessly in communication with the locking mechanism 218 via a network communication. The lock controller 216 is configured to receive a signal that instructs the locking mechanism 218 whether to mechanically engage or disengage the retention rod 215. For instance, the lock controller 216 may receive a radio frequency identification (RFID) signal or near field communication (NFC) signal from a tag, card, or user device (i.e., mobile device). Accordingly, an authorized user may instruct, via the tag, card, or user device, the locking mechanism 218 to engage or disengage the retention rod 215 to secure the retention rod 215 in the closed configuration or enable the retention rod 215 to operate from the closed configuration to the open configuration.

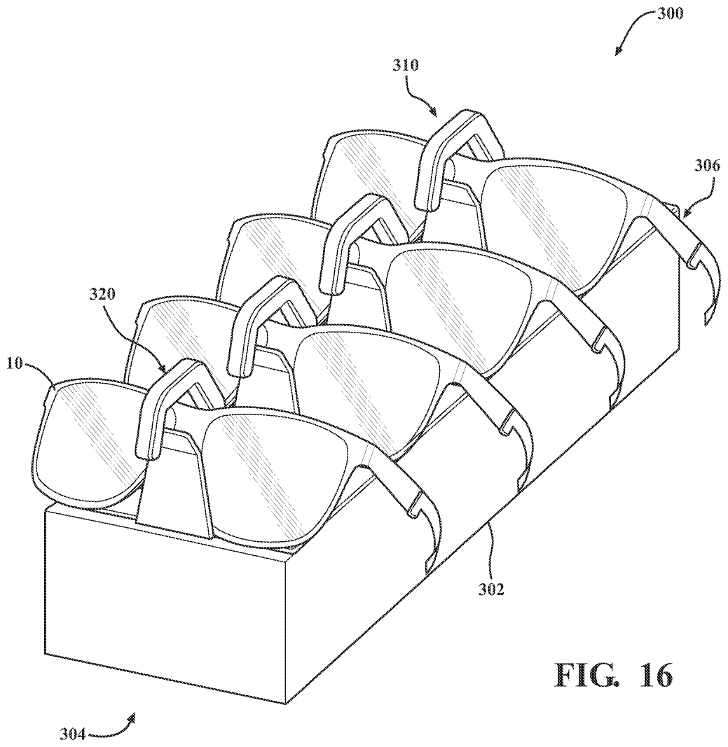

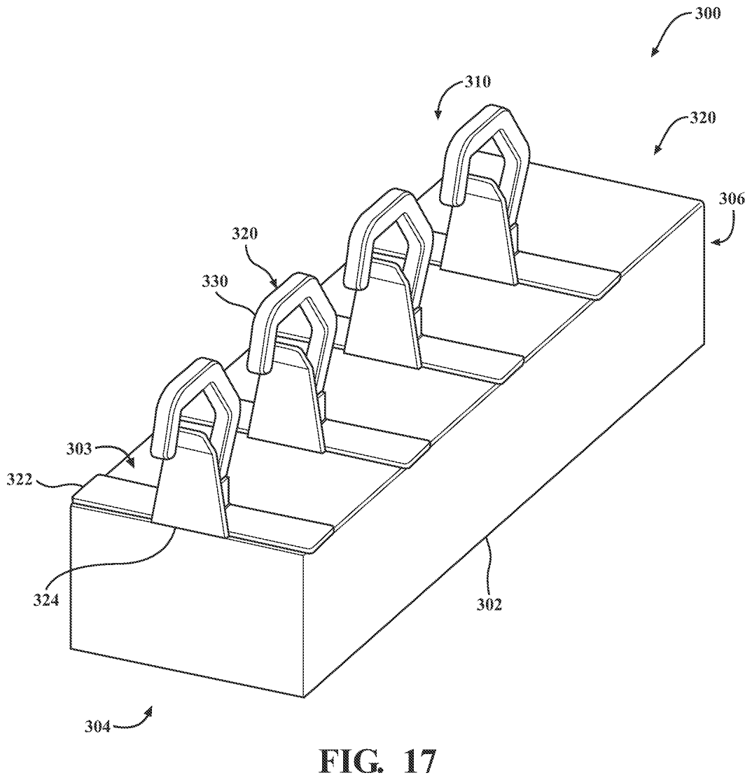

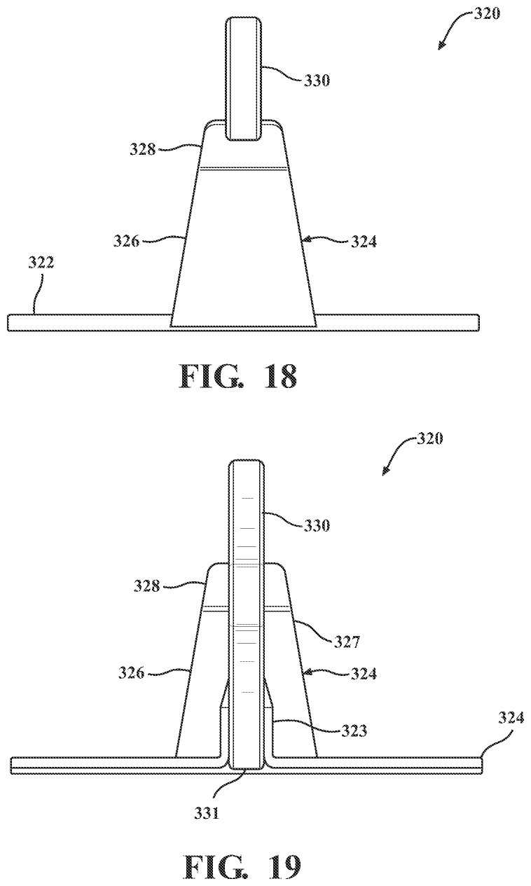

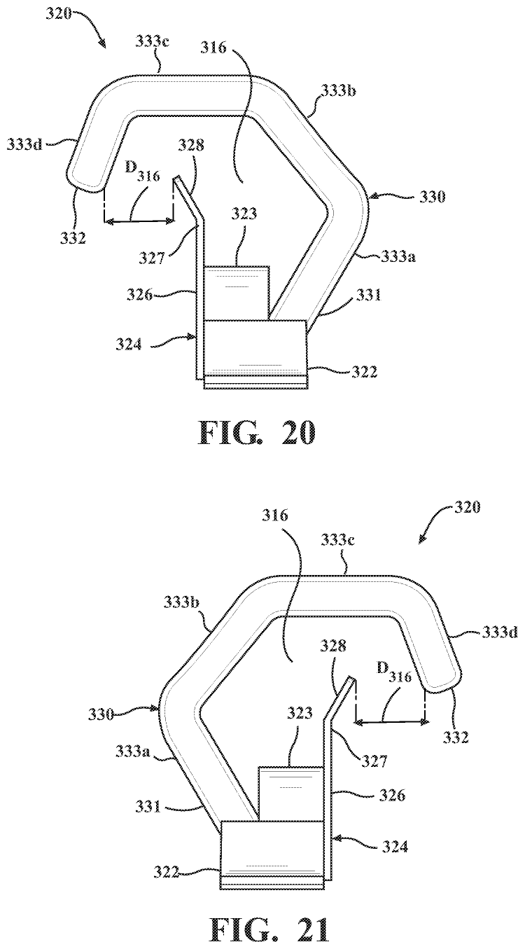

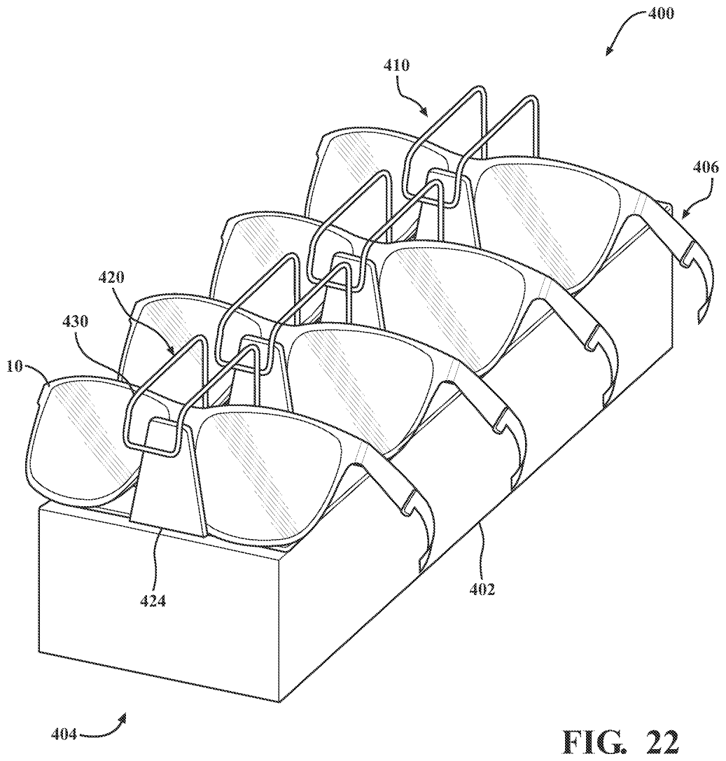

FIGS. 16-21 depict another example of the anti-theft device 300 including a base 302 and a retention mechanism 310 coupled to a portion of the base 302. The base 302 includes a support surface 303 such that the retention mechanism 310 is disposed on the support surface 303 of the base 302. The base 302 may be any structure that is capable of being secured to the retention mechanism 310 to prevent the theft of eyeglasses 10 on display. Moreover, the base 302 includes a first end 304 and a second end 306, the first end 304 opposite the second end 306. The retention mechanism 310 includes a plurality of retention members 320. For instance, the anti-theft device 300 shows the plurality of retention members 320 including four retention members 320, however, it is understood that the plurality of retention members 320 may include any number of retention members 320.

Each retention member 320 is operable to receive and secure a set of eyeglasses 10, and includes a retention base 322 attached to the support surface 303 of the base 302. The retention base 322 has a supporting feature 323 attached to the retention base 322. The supporting feature 323 is operable to receive and support at least a bridge or nose piece of the eyeglasses 10. In some examples, each retention member 320 includes a front retention element 324 and a retention hook 330. Here, the retention element 324 includes a lower portion that is attached to and extends away from a front side of the retention base 322, and the retention hook 330 is attached to and extending away from a rear side of the retention base 322. The retention element 324 includes a lower portion 326 attached to the retention base 322 and an upper portion 328 attached to a distal end of the straight portion 326. Particularly, the lower portion 326 defines a substantially straight wall extending in a vertical direction (i.e., perpendicular to the support surface 303) along the front side of the retention base 322 to a distal end 327 positioned above the retention base 322 relative to the support surface 312. The upper portion 328 includes a substantially straight wall segment extending at an oblique angle relative to the lower portion 326. Particularly, the upper portion 328 extends from the distal end 327 in a direction forward and upward relative to the retention base 323. In some examples, the supporting feature 323 is disposed adjacent to the lower portion 326.

The retention hook 330 extends from a first end portion 331 attached at a rear side of the retention base 322 and includes a second end portion 332 extending downwardly and spaced apart from the upper portion 328 by a predetermined distance D₃₁₆ to provide an opening into a receptacle 316 defined by the retention element 324 and the retention hook 330. Notably, the predetermined distance D₃₁₆ is a distance such that the eyeglasses 10 may be removed from, or placed within, the retention member 320. In the illustrated example, the retention hook 330 includes a plurality of hook segments 333a, 333b, 333c, 333d, extending between the first end 331 and the second end 332 to define a path for inserting and removing eyeglasses 10 from the receptacle 316. For instance, eyeglasses 10 may move in an up-over-and-down motion to be removed from, or placed within, the receptacle 316 of the retention member 320. Advantageously, by requiring the up-over-and-down motion to place or remove the eyeglasses 10, the retention member 320 inhibits customers from quickly removing eyeglasses 10 from within the retention mechanism 310. As such, even though the predetermined distance D₃₁₆ enables the eyeglasses 10 to be removed from the retention mechanism 310, the up-over-and-down motion required to remove the eyeglasses 10 prevents customers from quickly and inconspicuously removing the eyeglasses 10.

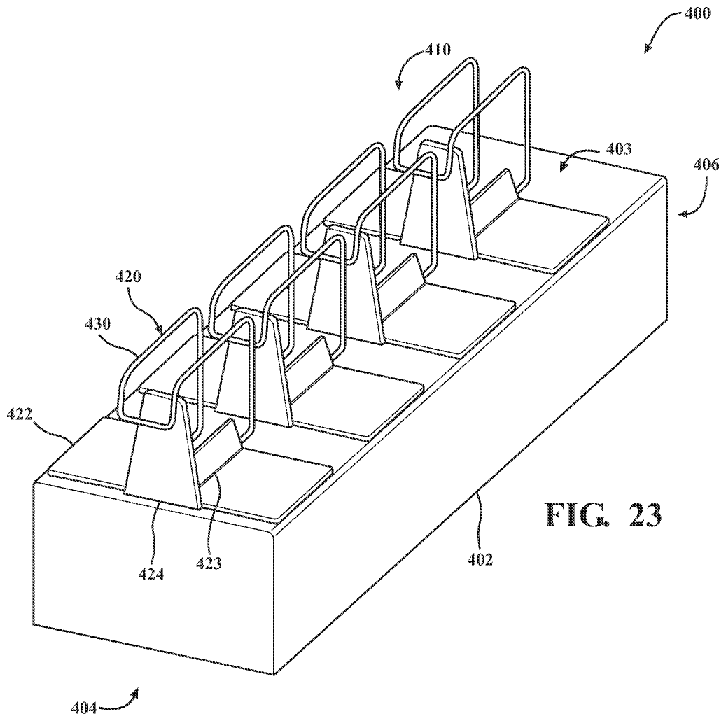

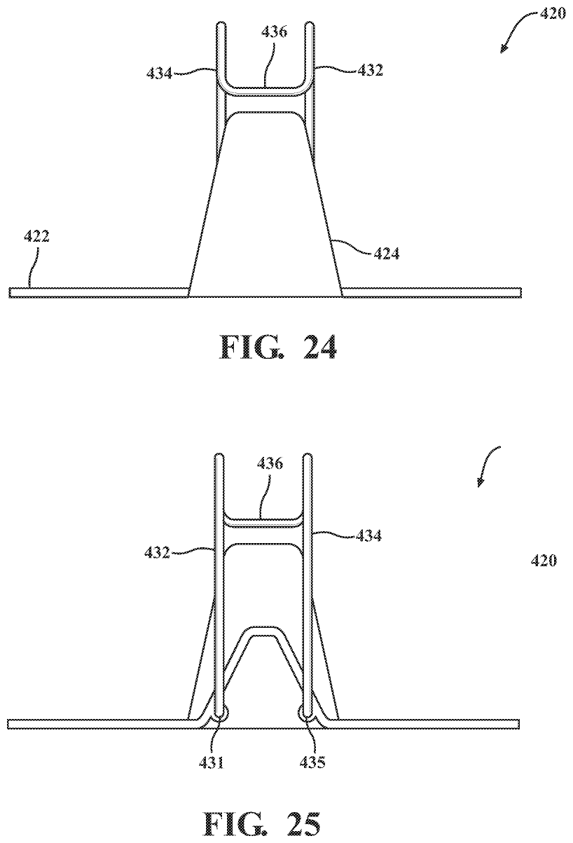

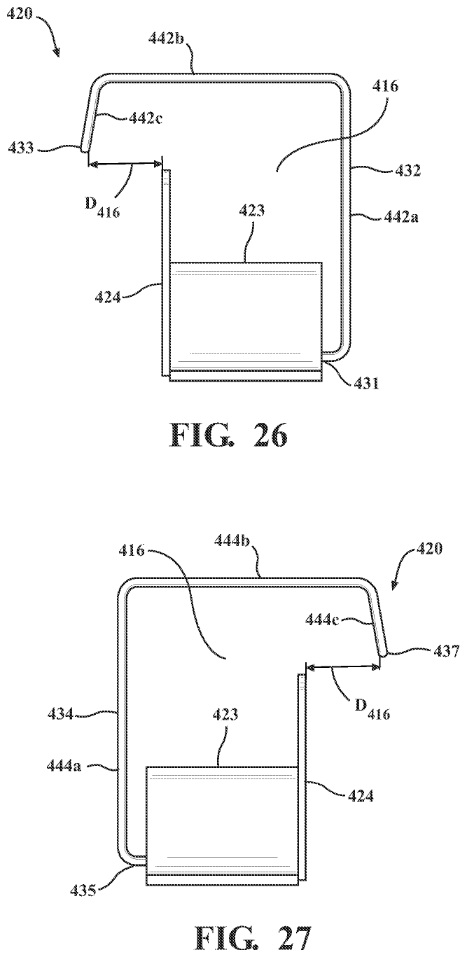

FIGS. 22-27 depict another example of an anti-theft device 400 including a base 402 and a retention mechanism 410 coupled to a portion of the base 402. The base 402 includes a support surface 403 such that the retention mechanism 410 is disposed on the support surface 403. The base 402 may be any structure that is capable of being secured to the retention mechanism 410 to prevent theft of eyeglasses on display. Moreover, the base 402 includes a first end 404 and a second end 406, the first end 404 opposite the second end 406. The retention mechanism 410 includes a plurality of retention members 420. For instance, the anti-theft device 400 shows the plurality of retention members 420 including four retention members 420, however, it is understood that the plurality of retention members 420 may include any number of retention members 420.

Each retention member 420 is operable to receive and secure one of a plurality of eyeglasses 10, and includes a retention base 422 attached to the surface of the base 402. The retention base has a supporting feature 423 attached to the retention base 422. The supporting feature 423 is operable to receive at least a bridge or nose piece of the eyeglasses 10. In some examples, each retention member 420 includes a retention element 424 and a retention hook 430. Here, the retention element 424 is attached to and extends away from a front side of the retention base 422. Particularly, the retention element 424 defines a substantially straight wall extending in a vertical direction (i.e., perpendicular to the support surface 403) along the front side of the retention base 422. In some examples, the supporting feature 423 is disposed adjacent to the retention element 424.

The retention hook 430 is attached to the supporting feature 423 and extends away from the retention base 422. The retention hook 430 includes a first arm 432 and a second arm 434 such that the first arm 432 is spaced apart from the second arm 434 by a predetermined spacing distance. The first arm 432 may mirror the second half. The first arm 432 extends from a proximal end 431 attached at a rear side of the supporting feature 423 to a distal end 433 extending downwardly. The second arm 434 extends from a proximal end 435 attached at the rear side of the supporting feature 423 to a distal end 437 extending downwardly. Moreover, the retention hook 430 includes a connecting portion 436 that connects the distal end 433 of the first arm 432 and the distal end 437 of the second arm 434. arm 432 arm 434 In some examples, the first arm 432 and the second arm 434 include a wire structure such whereby a void exists in the predetermined spacing distance between the first arm 432 and the second arm 434. In contrast, the retention hook 330 of the anti-theft device 300 includes a single integral structure rather than the first arm 432 and second arm 434 connected by the connecting portion 436.

The end portion 426 is spaced apart from the retention element 424 by a predetermined distance D₄₁₆ to provide an opening into a receptacle 416 defined by the retention element 424 and the retention hook 430. Notably, the predetermined distance D₄₁₆ is a distance such that the eyeglasses 10 may be removed from, or placed within, the retention member 420. In the illustrated example, the first arm 432 of the retention hook 430 includes a plurality of hook segments 442a, 442b, 442c, extending between the proximal end 431 and the distal end 433 of the first arm 432 and the second arm 434 of the retention hook 430 includes a plurality of hook segments 444a, 444b, 444c, extending between the proximal end 435 and the distal end 437 of the second arm 434. Here, the plurality of hook segments 442a, 442b, 442c of the first arm 432 and the plurality of hook segments 444a, 444b, 444c cooperatively define a path for inserting and removing eyeglasses from the receptacle 416. For instance, eyeglasses 10 may move in an up-over-and-down motion to be removed from, or placed within, the retention member 420. Advantageously, by requiring the up-over-and-down motion to place or remove the eyeglasses 10, the retention member 420 inhibits customers from quickly removing eyeglasses 10 from within the retention mechanism 410. As such, even though the predetermined distance D₄₁₆ enables the eyeglasses 10 to be removed from the retention mechanism 410, the up-over-and-down motion required to remove the eyeglasses 10 prevents customers from quickly and inconspicuously removing the eyeglasses 10.

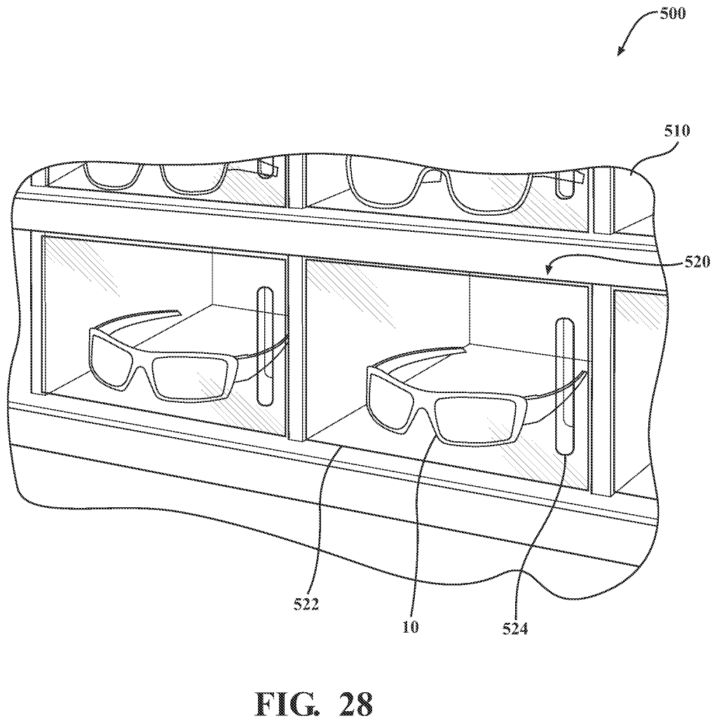

FIGS. 28-30 depict another example of the anti-theft device 500 including a retention mechanism 510 having a plurality of retention display cases 520. The plurality of retention display cases 520 may be stacked and/or disposed adjacent to one another. Each retention display case 520 may include a base capable of supporting eyeglasses 10 on top thereof and within the retention display case 520. The retention display case 520 may be any structure that is capable of preventing the theft of eyeglasses 10 on display within the retention display case 520. In particular, each retention display case 520 includes an opening and an associated retention door 522 rotatably attached to the retention display case 520. The retention door 522 includes a handle 524 and is configured to secure the eyeglasses 10 within the retention display case 520. The retention door 522 may include a transparent material such that customers can see through the retention door 522 to view eyeglasses 10 secured within the retention display case 520.

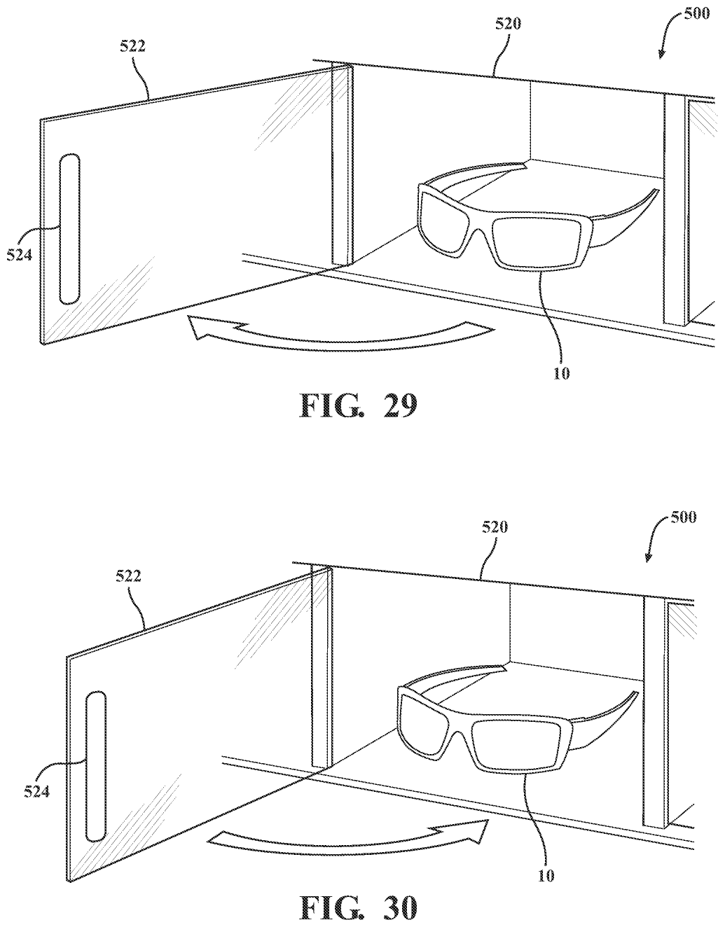

The retention display case 520 includes a closed configuration (FIG. 28) and an open configuration (FIGS. 29 and 30). In the closed configuration, the retention door 522 is closed such that the opening of the retention display case 520 may not be accessed, and thus, the eyeglasses 10 may not be removed from, or placed within, the retention display case 520. In the open configuration, the retention door 522 rotates open such that the opening of the retention display case 520 may be accessed, and thus, the eyeglasses 10 may be removed from, or placed within, the retention display case 520. The handle 524 is operable for a user to grasp in order to rotate the retention door 522 between the closed configuration and the open configuration (i.e., rotate the retention door 622 open and closed).

In some examples, each retention door 522 is attached to a single retention display case 520. Thus, each retention door 522 operates between the closed configuration and the open configuration for a single retention display case 520. That is, each retention door 522 secures eyeglasses 10 within a single retention display. Thus, each retention door 522 may operate between the closed configuration and the open configuration independent from the configuration of other retention doors 522 attached to other retention display cases 520. In some examples, each retention display case 520 includes a locking mechanism configured to mechanically engage and secure the retention door 522 in the closed configuration.

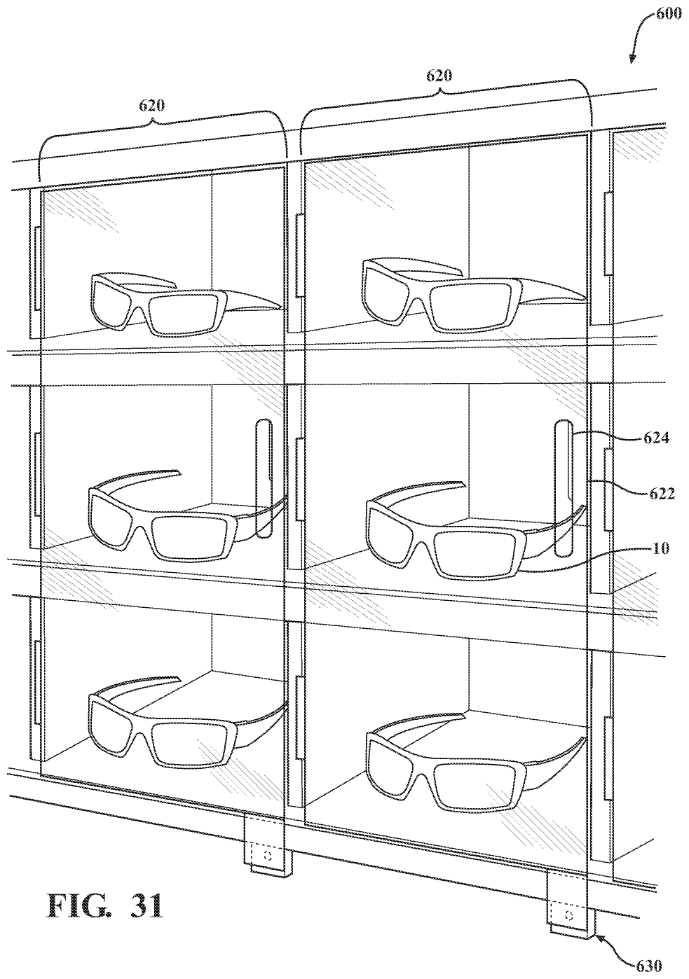

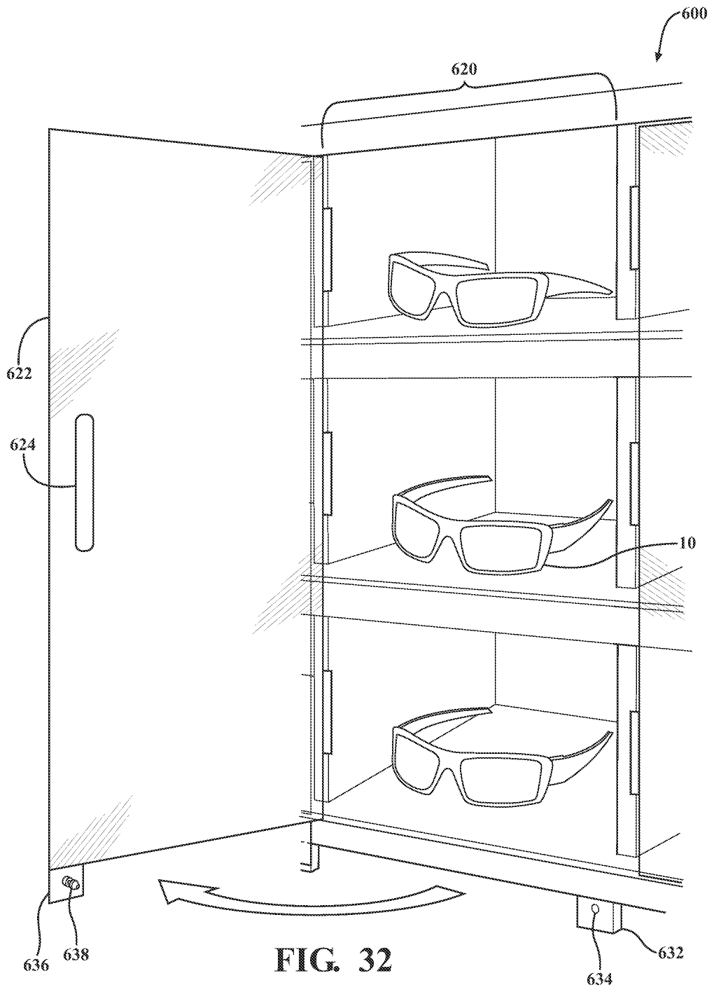

FIGS. 31-34 depict another example of the anti-theft device 600 including a retention mechanism 610 having a plurality of retention display case stacks 620. Each retention display case stack 620 one or more retention display cases 620. In the example shown, each retention display case stack 620 includes three retention display cases 620, however, it is understood that any number of retention display cases 620 may be included in the retention display case stack 620. Moreover, one or more retention display case stacks 620 may be stacked on top of one another and/or adjacent one another.

Each retention display case 620 includes a base capable of supporting eyeglasses 10 on top thereof and within the retention display case 620. The retention display cases 620 may include any structure that is capable of preventing the theft of eyeglasses 10 on display within the retention display case 620. In particular, each retention display case includes an opening and an associated retention door 622 rotatably attached to the retention display case 620. The retention door 622 includes a handle 624 and is configured to secure the eyeglasses within the retention display case 620. The retention door 622 may include a transparent material such that customers can see through the retention door 622 to view eyeglasses 10 secured within the retention display case 620.

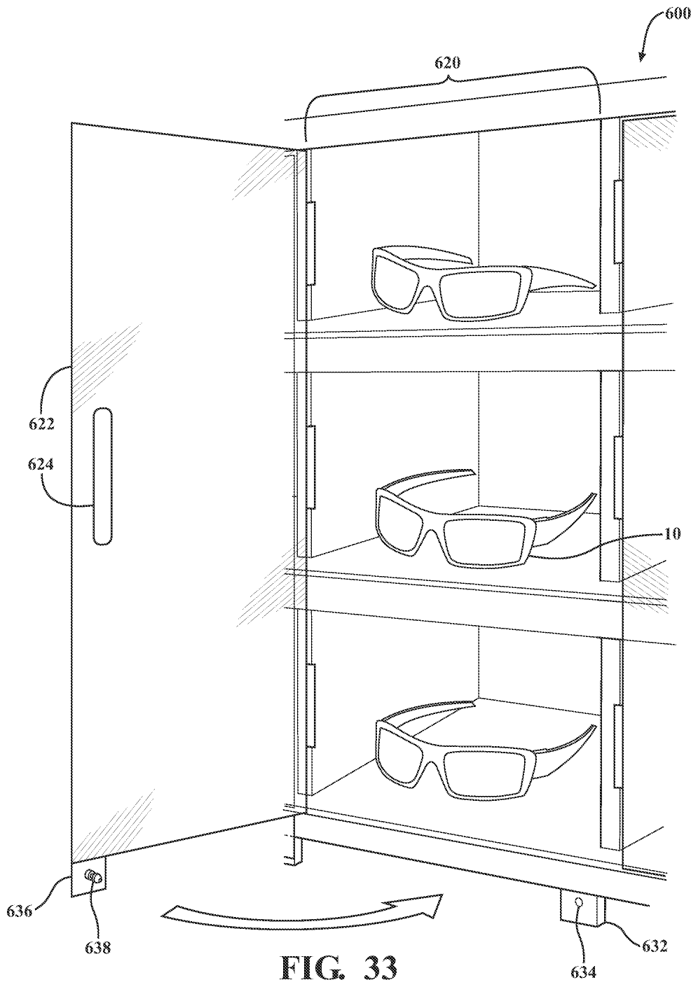

In contrast to the example of the anti-theft device 500 where each retention door 522 is associated with a single retention display case 520, each retention door 622 of the anti-theft device 600 is associated with each retention display case 620 of the stack of retention display cases 620. Stated differently, each retention door 622 is attached to each retention display case 620 of the stack of retention display cases 620, and thus, is configured to secure the eyeglasses 10 within each retention display case 620 of the stack of retention display cases 620. Thus, in the example shown, each retention door is associated with three retention display cases 620 in the stack of retention display cases 620. The handle 624 is operable for a user to grasp in order to rotate the retention door 622 between a closed configuration and an open configuration (i.e., rotate the retention door 622 open and closed). Thus, each retention door 622 operates between the closed configuration (FIG. 31) and the open configuration (FIGS. 32 and 33) for each retention display case 620 of the retention display case stack 620. Yet, each retention door may operate between the closed configuration and the open configuration for the associated retention display case stack 620 independent from the configuration of other retention doors 622 attached to other retention display case stacks 620.

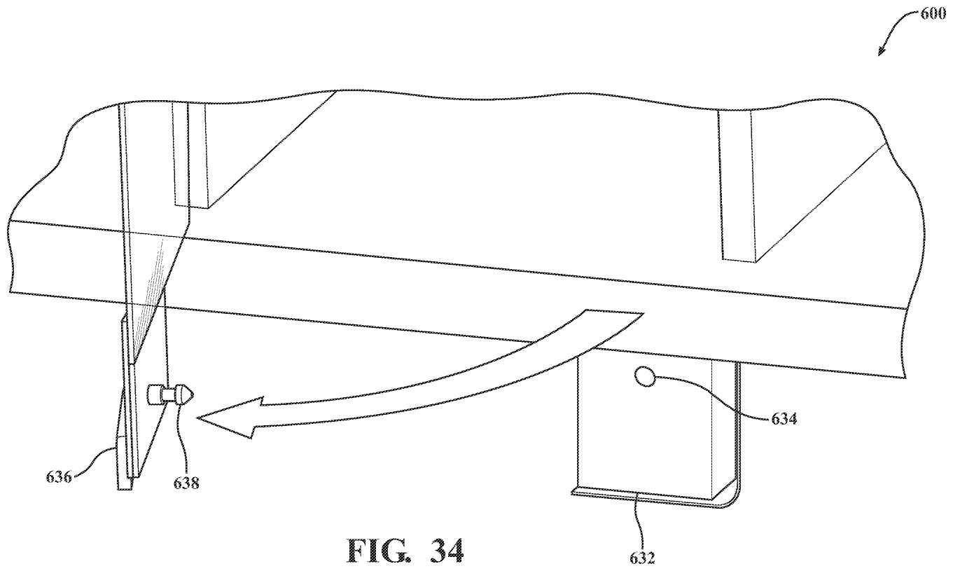

As shown in FIG. 34, in some examples, each stack of retention display cases 620 includes a locking mechanism 630. The locking mechanism may include a female locking feature 632 having a locking hole 634, and a male locking feature 636 having a locking pin 638. The male locking feature 636 may be attached to the retention door 622. Here, the locking pin 638 is configured to engage the locking hole 634 and secure the retention door 622 in the closed configuration. In some examples, the female locking feature 632 mechanically engages the locking pin 638 such that the retention door 622 is secured in the closed configuration. In some examples, the female locking feature 632 may lock the locking pin 638 such that the retention door 622 may not operate from the closed configuration to the open configuration.

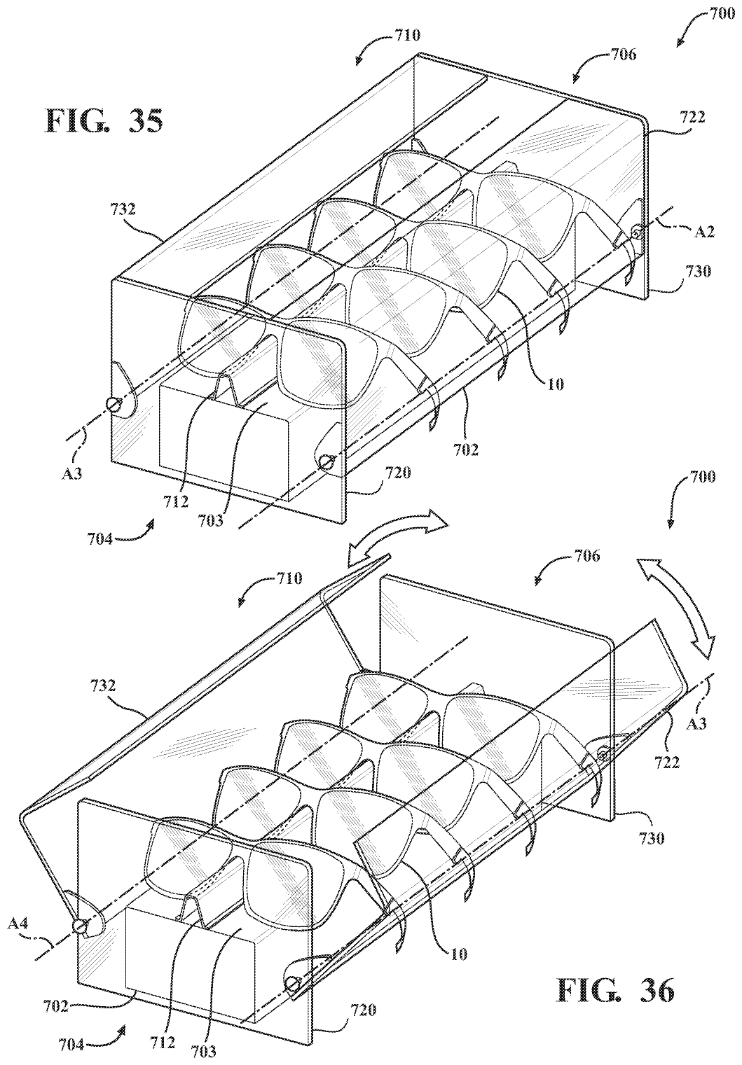

FIGS. 35 and 36 depict another example of the anti-theft device 700 including a base 702, and a retention mechanism 710 coupled to a portion of the base 702. The base 702 includes a support surface 703 such that the retention mechanism 710 is disposed on the support surface 703 of the base 702. The base 702 may be any structure that is capable of being secured to the retention mechanism 710 to prevent the theft of eyeglasses on display. Moreover, the base 702 includes a first end 704 and a second end 706 where the first end 704 is opposite the second end 706. The retention mechanism 710 includes a frame 712 attached to the support surface 703 of the base 702 and extending from the first end 704 to the second end 706. The frame 712 is configured to receive and support at least a bridge or a nose pad of the eyeglasses 10 on display.

The retention mechanism 710 is configured to secure the eyeglasses 10 within the anti-theft device 700. The retention mechanism 710 includes a first retention member 720, a second retention member 730, a first retention element 722, and a second retention element 732. In some examples, the first retention member 720, the second retention member 730, the first retention element 722, and the second retention element 732 include a transparent material such that a customer can see through retention mechanism 710. The first retention member 720 is attached to the retention mechanism 710 at the first end 704 of the base 702 and the second retention member 730 is attached to the retention mechanism 710 at the second end 706 of the base 702. Moreover, the first retention element 722 is rotatably attached to first retention member 720 and the second retention member 730 whereby the first retention element 722 is configured to rotate between a closed configuration and an open configuration about a first rotational axis A2. Here, the first rotational axis A3 extends from the first retention member 720 to the second retention member 730. The second retention element 732 is rotatably attached to the first retention member 720 and the second retention member 730 whereby the second retention element 732 is configured to rotate between the closed configuration and the open configuration about a second rotational axis A4. Here, the second rotational axis A4 extends from the first retention member 720 to the second retention member 730 and may be parallel to the first rotational axis A3.

In some examples, the first retention element 722 and the second retention element 732 may operate (i.e., rotate) between the closed configuration and the open configuration independently of one another. Thus, in the closed configuration, the first retention element 722 and the second retention element 732 are rotated to a closed position thereby defining a closed area such that eyeglasses 10 may not be provided within, or removed from, the retention mechanism 710 as shown in FIG. 35. On the other hand, in the open configuration, the first retention element 722 and the second retention element 732 are rotated to an open position so as to define an open area whereby eyeglasses may be provided within, or removed from, the retention mechanism 710 as shown in FIG. 36.

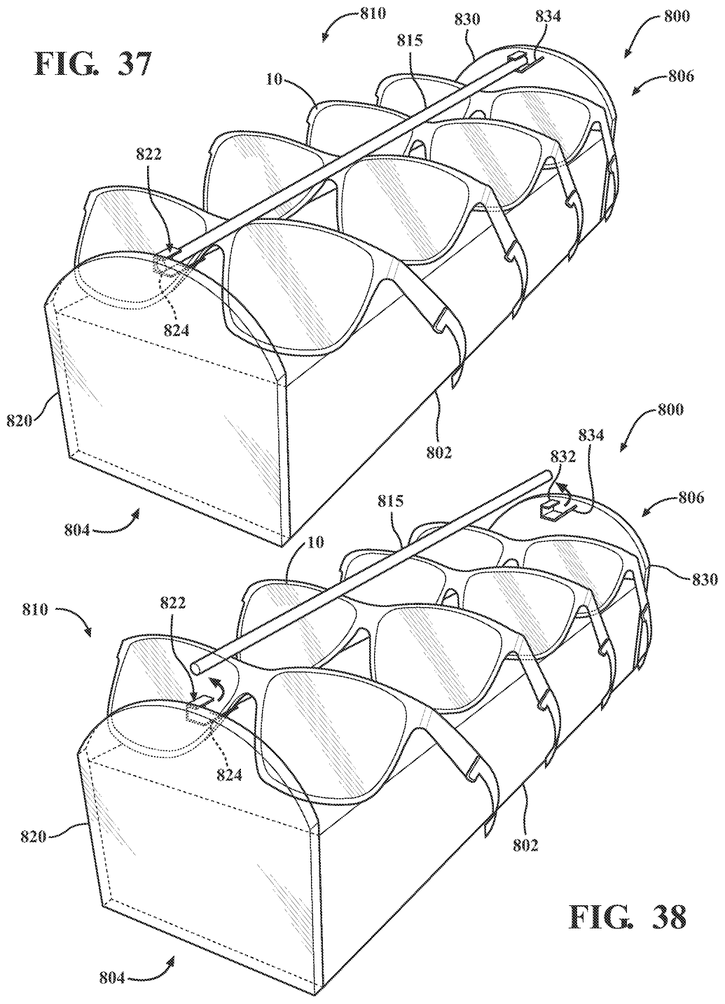

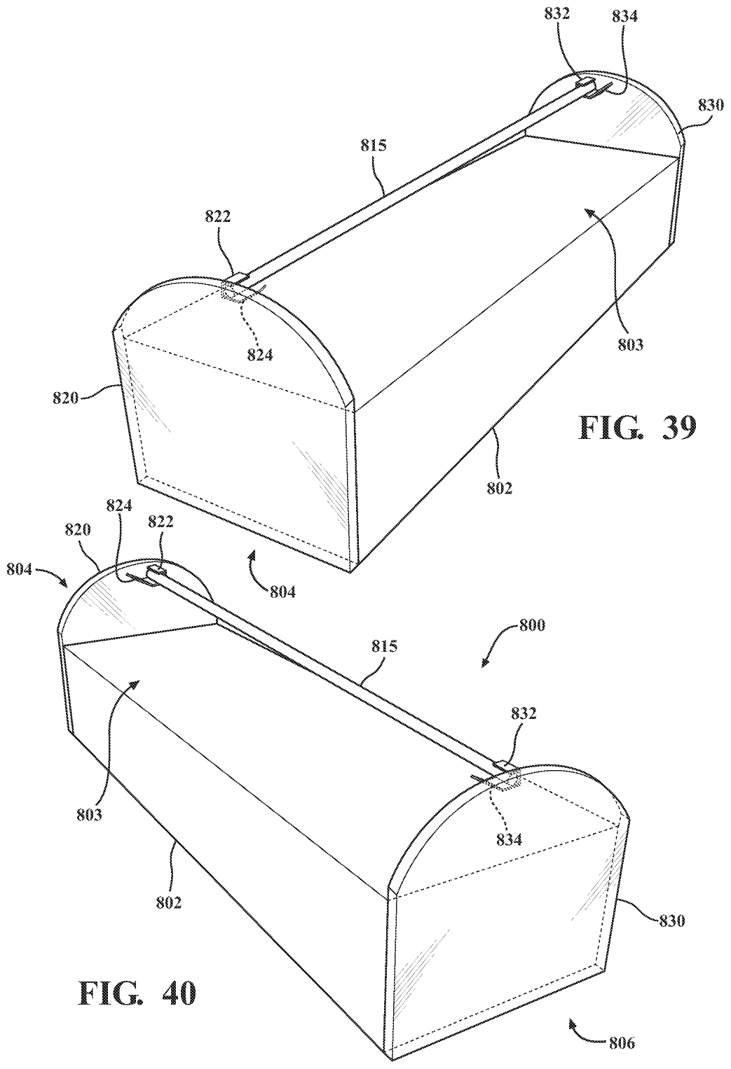

FIGS. 37-40 depict an eighth examples of the anti-theft device 800 including a base 802, and a retention mechanism 810 coupled to a portion of the base 802. The base 802 includes a support surface 803 such that the retention mechanism 810 is deposed on the support surface 803 of the base 802. The base 802 may be any structure that is capable of being secured to the retention mechanism 810 to prevent the theft of eyeglasses on display. Moreover, the base 802 includes a first end 804 and a second end 806, the first end 804 opposite the second end 806. The base 802 includes a surface and is configured to receive and support a portion of the eyeglasses 10 on display. Stated differently, the eyeglasses 10 on display may be disposed at the surface of the base 802.

The retention mechanism includes a retention rod 815, a first retention member 820, and a second retention member 830. The first retention member 820 is coupled to the first end 804 of the base 802 and the second retention member 830 is coupled to the second end 806 of the base 802. The first retention member 820 includes a first receiving portion 822 and the second retention member 830 includes a second receiving portion 832. In some examples, the first receiving portion 822 includes a bracket and the second receiving portion 832 includes another bracket that mirrors the bracket from the first receiving portion 822. The first receiving portion 822 is configured to receive a proximal end of the retention rod 815 and the second receiving portion is configured to receive a distal end of the retention rod 815. Thus, the first receiving portion 822 and the second receiving portion 832 are configured to secure the retention rod 815 to the retention mechanism 810. In some examples, the first receiving portion 822 includes a first tab 824 and the second receiving portion 832 includes a second tab 834. The first tab 824 and the second tab 834 are configured to prevent the retention rod 815 from rolling out of the first receiving portion 822 and the second receiving portion 832. Put another way, the first tab 824 and the second tab 834 secure the retention rod 815 in the first receiving portion 822 and the second receiving portion 832, respectively.

The retention mechanism 810 includes a closed configuration and an open configuration. In the closed configuration, the first receiving portion 822 engages the retention rod 815 and the second receiving portion 832 engages the retention rod. Here, the retention rod 815 extends above the surface of the base 802 from the first end 804 to the second end 806 of the base 802. Moreover, in the closed configuration, a distance between the retention rod 815 and the surface of the base 802 is defined such that the eyeglasses 10 may not be removed from, or placed within, the retention mechanism 810. That is, as shown in FIGS. 37, 39, and 40, the distance between the base 802 and the retention rod 815 in the closed configuration is smaller than the shape or geometry of the eyeglasses such that the distance does not allow eyeglasses 10 to move between the retention rod 815 and the base 802. On the other hand, in the open configuration, the distance between the retention rod 815 and the surface of the base 802 is such that the eyeglasses may be removed from, or placed within, the retention mechanism 810. That is, as shown in FIG. 38, the retention rod 815 is disengaged from the first receiving portion 822 and the second receiving portion 832, and thus, eyeglasses may be placed onto, or removed from, the base 802.

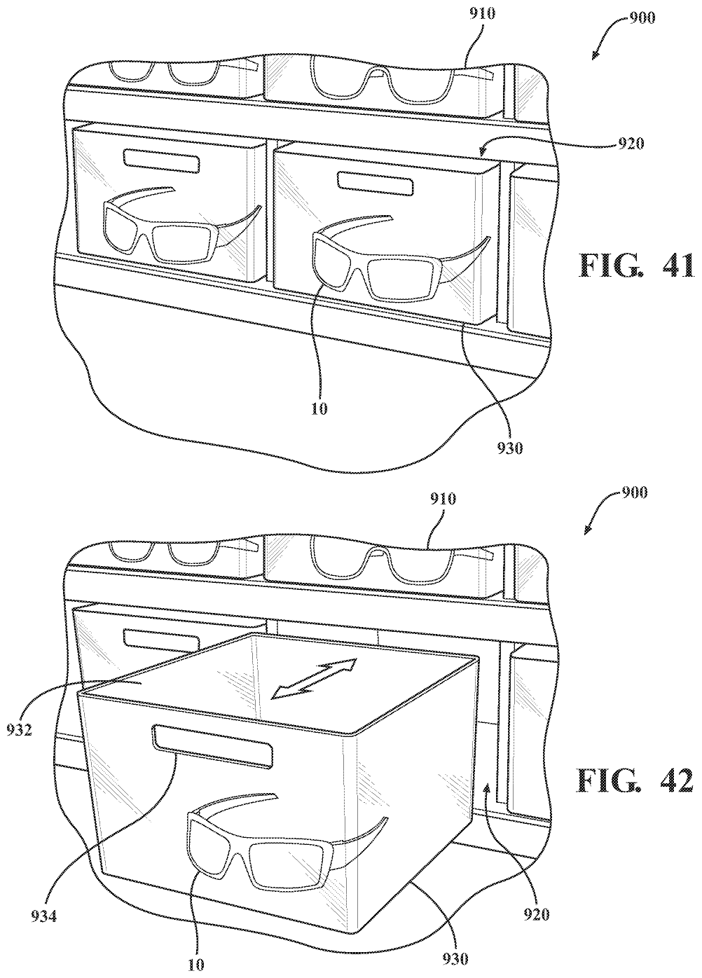

FIGS. 41 and 42 depict a ninth example of the anti-theft device 900 including a retention mechanism 910 having a plurality of retention display cases 920. Each retention display case 920 includes an opening configured to receive a retention container 930. The retention container includes a transparent material such that customers can view the eyeglasses 10 on display and stored within the retention container 930. That is, each retention container 930 includes an open top-side 932 such that eyeglasses 10 may be removed from, or placed within, the retention container 930. That is, the retention container 930 are operable to store eyeglasses 10 within the retention container 930.

Each retention display case 920 includes a closed configuration and an open configuration. In the closed configuration, the retention container 930 is stored within the opening of the retention display case 920 such that the open top-side 932 of the retention container 930 may not be accessed. Simply put, in the closed configuration, when the retention container 930 is stored within the retention display case 920, eyeglasses 10 cannot be removed from, or placed within, the retention container 930. On the other hand, in the open configuration, the retention container 930 is separate from the retention display case 920 such that the open top-side 932 of the retention container 930 is accessible to remove eyeglasses 10 from the retention container 930 or place eyeglasses within the retention container 930. In some examples, the retention containers 930 each include a handle 934 operable to grasp and move the retention container 930 into the retention display case 920 or remove the retention container 930 from the retention display case 920.

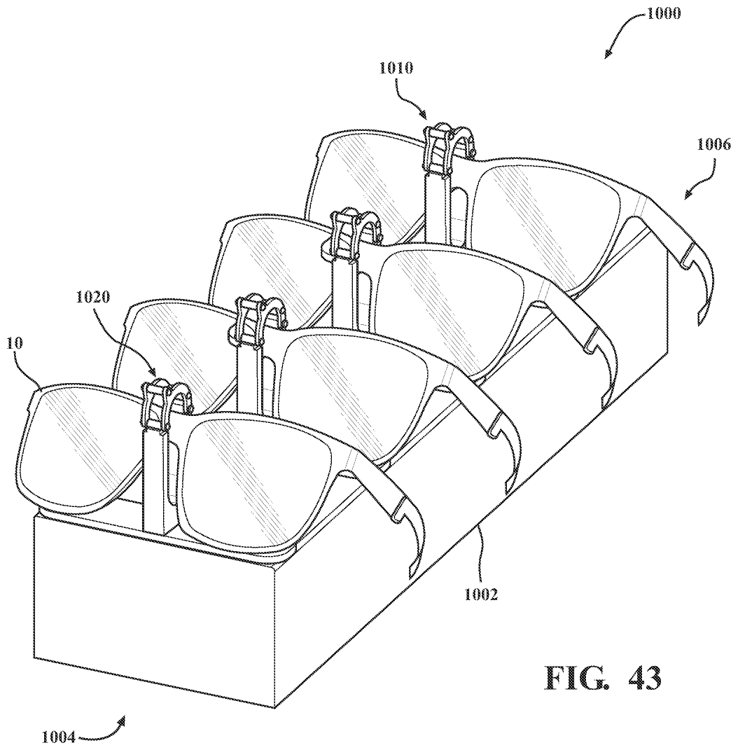

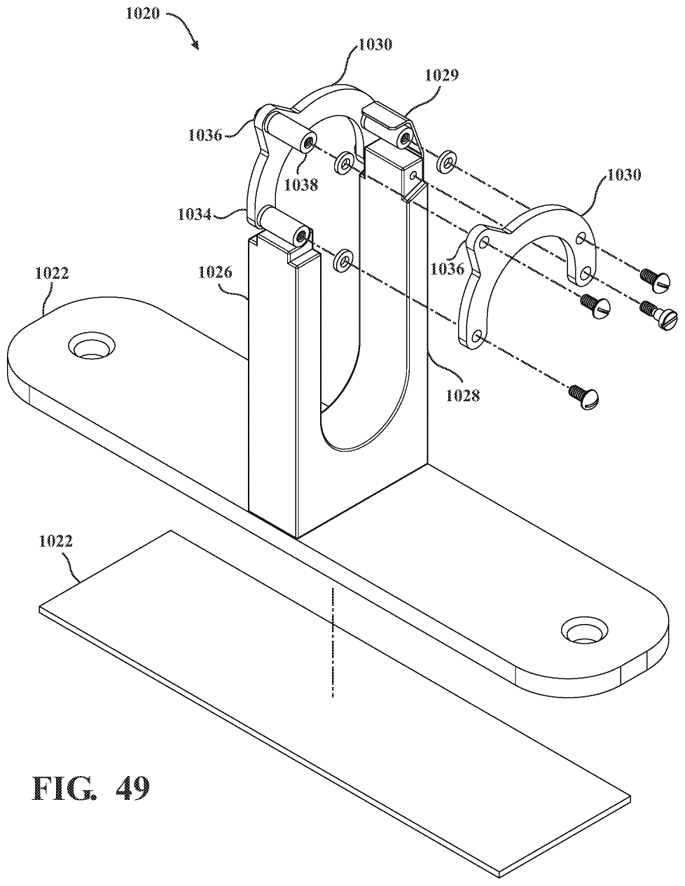

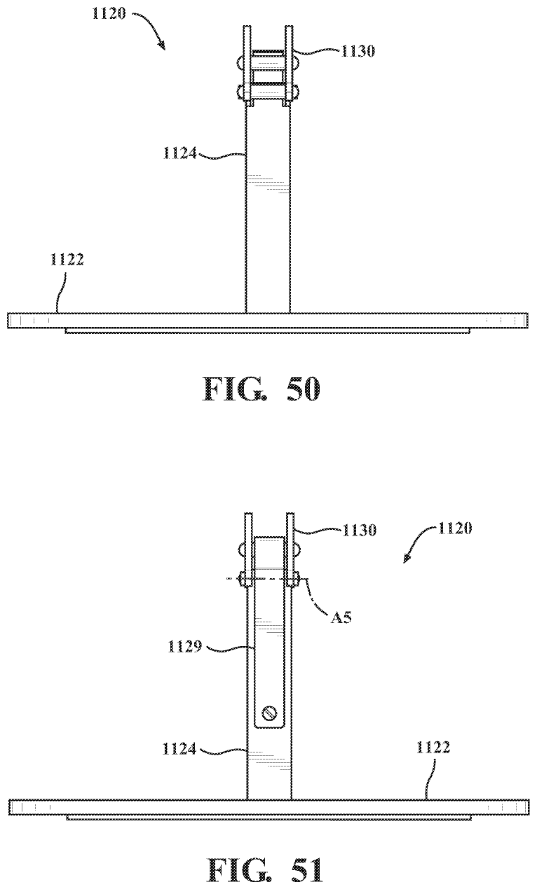

FIGS. 43-49 depict another example of an anti-theft device 1000 including a base 1002 and a retention mechanism 1010 coupled to a portion of the base 1002. The base 1002 includes a support surface 1003 such that the retention mechanism 1010 is attached to the support surface 1003 of the base 1002. The base 1002 may be any structure that is capable of being secured to the retention mechanism 1010 to prevent the theft of eyeglasses 10 on display. Moreover, the base 1002 includes a first end 1004 and a second end 1006, the first end 1004 opposite the second end 1006. The retention mechanism 1010 includes a plurality of retention members 1020 disposed on the support surface 1003 of the base 1002. For instance, the tenth example of the anti-theft device 1000 shows the plurality of retention members 1020 including four retention members 1020, however, it is understood that the plurality of retention members 1020 may include any number of retention members 1020.

Each retention member 1020 is operable to receive and secure one of a plurality of eyeglasses, and includes a retention base 1022 disposed on the support surface 1003 of the base 1002. The retention member 1020 has a cradle 1024 attached to the retention base 1022 and a retention hook 1030 rotatably attached at a distal end of the cradle 1024. The cradle 1024 and the retention hook 1030 cooperate to define a receptacle 1016 for receiving a bridge portion of the eyeglasses 10. As shown, the cradle 1024 includes a concave bottom surface 1025 wherein an open end of the concave bottom surface 1025 faces upwards towards the retention hook 1030. The concave bottom surface 1025 automatically centers the eyeglasses 10 within the retention member 1020. The cradle 1024 may also include a first arm 1026 and a second arm 1028 spaced apart from the first arm 1026 to define the receptacle 1016. The first arm 1024 and the second arm 1028 are attached to the concave bottom surface 1025. The first arm 1026 has a socket 1027 at a distal end of the first arm 1026, and the second arm 1028 has a fourth axis A4 extending through a distal end of the second arm 1028. The first arm 1026 has a third length L3 and the second arm 1028 has a fourth length L4 that is equal to the third length L3. Notably, the third length L3 of the first arm 1026 defines a distance that the eyeglasses 10 need to move vertically to remove the eyeglasses 10 from within the retention member 1020.

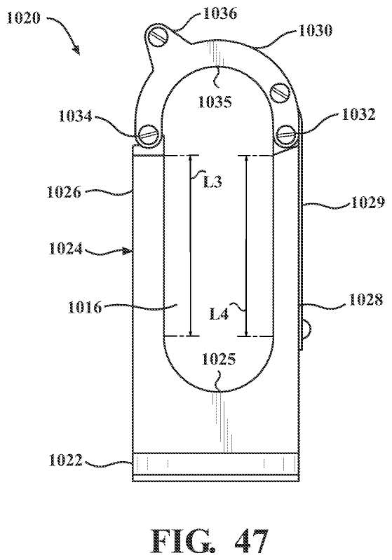

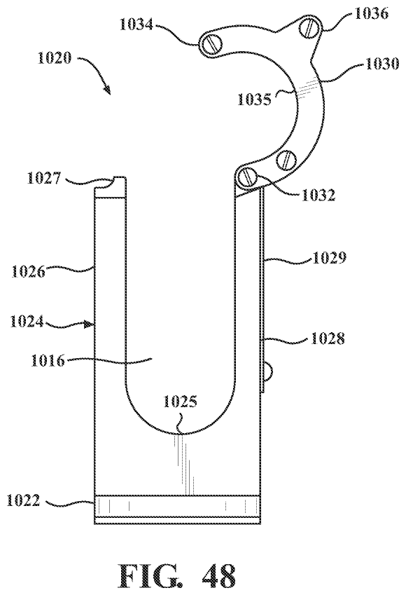

The retention hook 1030 includes a first end 1032 and a second end 1034 whereby the first end 1032 may be rotatably attached to a distal end of the second arm 1028. The retention hook 1030 includes a concave surface 1035 wherein an open end of the concave surface 1035 faces downwards. More specifically, the open end of the concave surface 1035 of the retention hook 1030 faces downwards towards the concave bottom surface 1025 of the cradle 1020 when the retention hook 1030 is in a closed configuration. The retention hook 1030 may also include a protrusion 1036 that extends radially outwardly from the retention hook 1030. That is, the protrusion 1036 extends radially outwardly from a location of the retention hook 1030 located between the first end 1032 and the second end 1034 of the retention hook 1030. The protrusion 1036 includes a cross member 1038 that connects a first half of the protrusion 1036 to a second half of the protrusion 1036. The protrusion 1036 provides a surface that a user may interact with (e.g., grasp) to open or close the retention hook 1030. Thus, the retention hook 1030 is operable to rotate about the fourth axis A4 between the closed configuration and an open configuration. In the closed configuration, the receptacle 1016 of the retention element 1024 and the retention hook 1030 define a closed area such that eyeglasses 10 may not be placed within, or removed from the receptacle 1016, as shown in FIG. 47. In the closed configuration, the second end 1034 of the retention hook 1030 interfaces with the socket 1027 at the distal end of the first arm 1026. On the other hand, in the open configuration, the retention element 1024 and the retention hook 1030 define an open area such that eyeglasses 10 may be placed within, or removed from, the receptacle 1016 as shown in FIG. 48. In some examples, the retention member 1020 includes a biasing member 1029 attached to the second arm 1028 of the retention element 1024 and the first end 1032 of the retention hook 1030. As such, the biasing member 1029 biases by applying a biasing force to the retention hook 1030 to bias the retention hook 1030 in the closed configuration. In some examples, the biasing member 1029 locks the retention hook 1030 in the closed configuration.

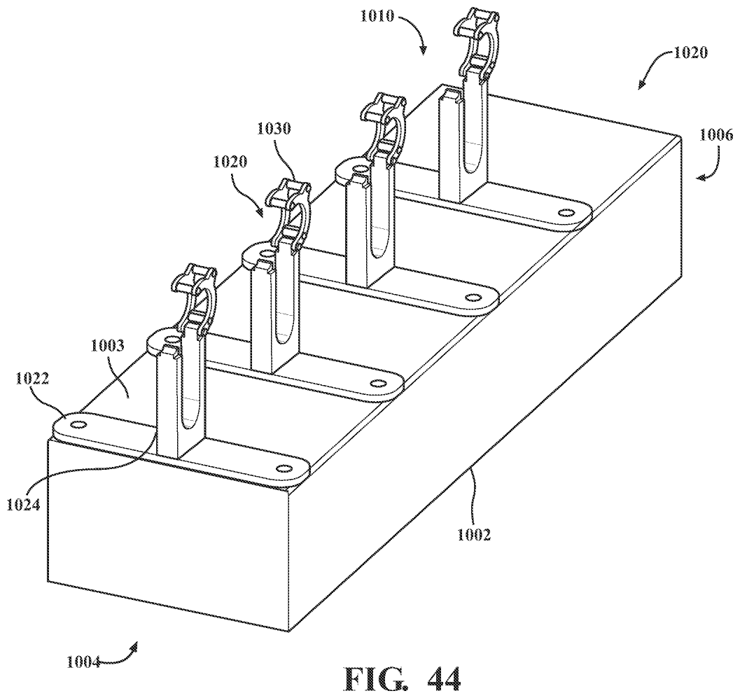

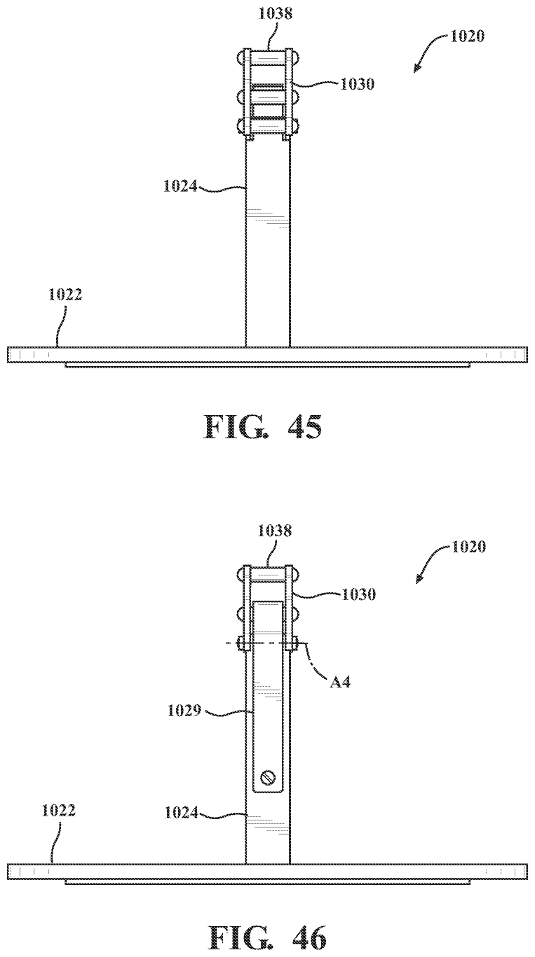

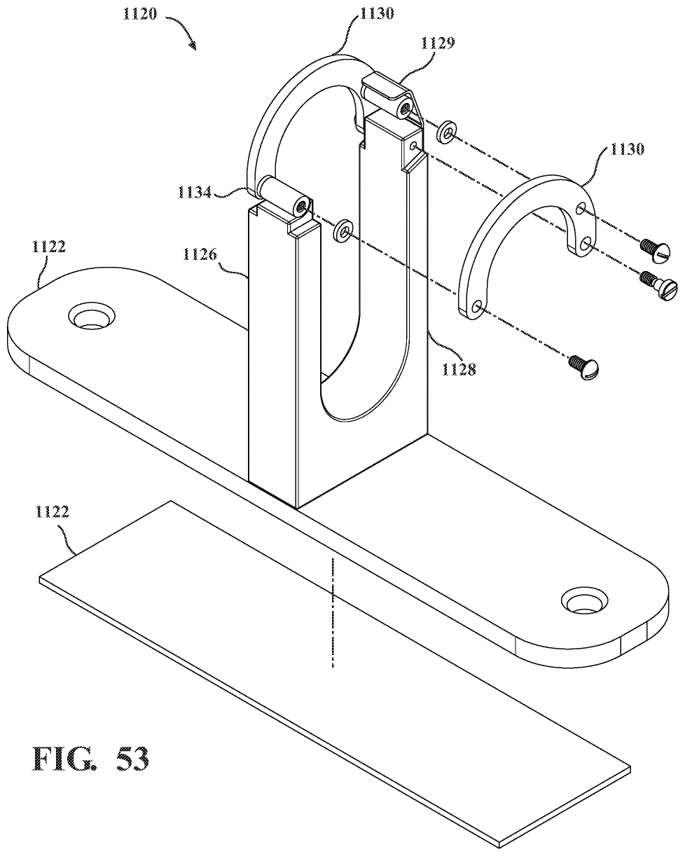

FIGS. 50-53 depict another example of a single retention member 1120. One or more of the retention members 1120 may be disposed on the support surface 1003 of the base 1002 of the anti-theft device 1000 in addition to, or in lieu of, the retention members 1020 (FIG. 44). In short, the retention member 1120 is substantially similar to the retention members 1020 (FIGS. 45-48), but the retention member 1120 does not include the protrusion 1036 nor the cross member 1038. As such, each retention member 1120 is operable to receive and secure one of a plurality of eyeglasses 10, and includes a retention base 1122 that may be disposed on the support surface 1003 of the base 1002 (FIG. 44). The retention member 1120 has a cradle 1124 attached to the retention base 1122 and a retention hook 1130 rotatably attached at a distal end of the cradle 1124. The cradle 1124 and the retention hook 1130 cooperate to define a receptacle 1116 for receiving a bridge portion of the eyeglasses 10. As shown, the cradle 1124 includes a concave bottom surface 1125 wherein an open end of the concave bottom surface 1125 faces upwards towards the retention hook 1130. The concave bottom surface 1125 automatically centers the eyeglasses 10 within the retention member 1120. The cradle 1124 may also include a first arm 1126 and a second arm 1128 spaced apart from the first arm 1126 to define the receptacle 1116. The first arm 1124 and the second arm 1128 are attached to the concave bottom surface 1125. The first arm 1126 has a socket 1127 at a distal end of the first arm 1126, and the second arm 1128 has a fifth axis A5 extending through a distal end of the second arm 1128. The first arm 1126 has a fifth length L5 and the second arm 1128 has a sixth length L6 that is equal to the fifth length L5. Notably, the fifth length L5 of the first arm 1126 defines a distance that the eyeglasses 10 need to move vertically to remove the eyeglasses 10 from within the retention member 1120.

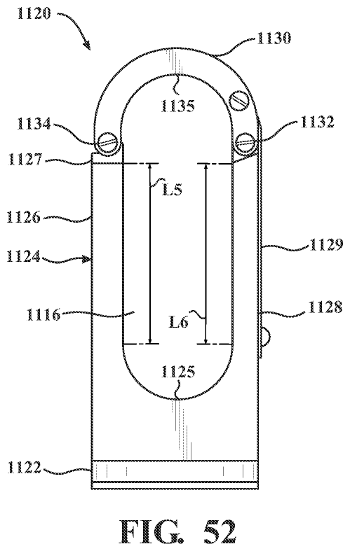

The retention hook 1130 includes a first end 1132 and a second end 1134 whereby the first end 1132 may be rotatably attached to a distal end of the second arm 1128. The retention hook 1130 includes a concave surface 1135 wherein an open end of the concave surface 1135 faces downwards. More specifically, the open end of the concave surface 1135 of the retention hook 1130 faces downwards towards the concave bottom surface 1125 of the cradle 1120 when the retention hook 1130 is in a closed configuration. Thus, the retention hook 1130 is operable to rotate about the fifth axis A5 between the closed configuration and an open configuration. In the closed configuration, the receptacle 1116 of the retention element 1124 and the retention hook 1130 define a closed area such that eyeglasses 10 may not be placed within, or removed from the receptacle 1116, as shown in FIG. 52. In the closed configuration, the second end 1134 of the retention hook 1130 interfaces with the socket 1127 at the distal end of the first arm 1126. On the other hand, in the open configuration, the retention element 1124 and the retention hook 1130 define an open area such that eyeglasses 10 may be placed within, or removed from, the receptacle 1116. In some examples, the retention member 1120 includes a biasing member 1129 attached to the second arm 1128 of the retention element 1124 and the first end 1132 of the retention hook 1130. As such, the biasing member 1129 biases by applying a biasing force to the retention hook 1130 to bias the retention hook 1130 in the closed configuration. In some examples, the biasing member 1129 locks the retention hook 1130 in the closed configuration.

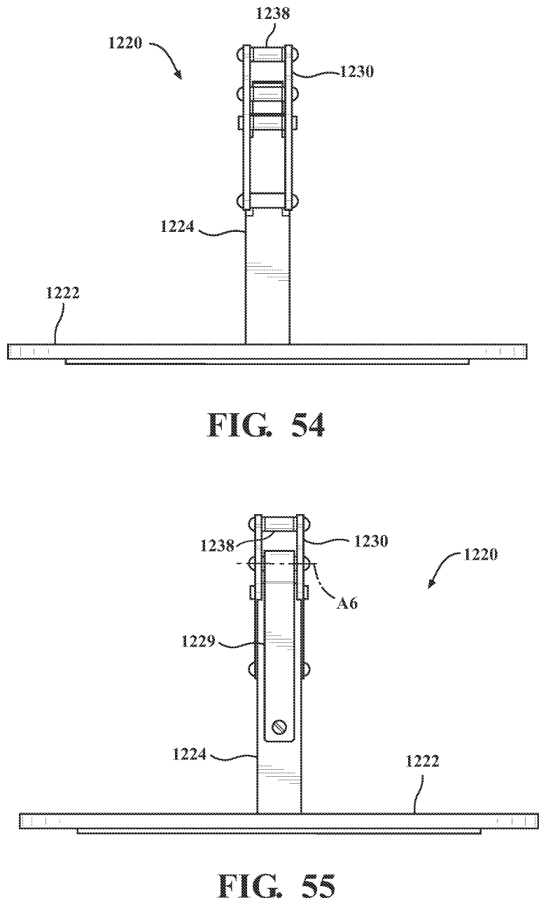

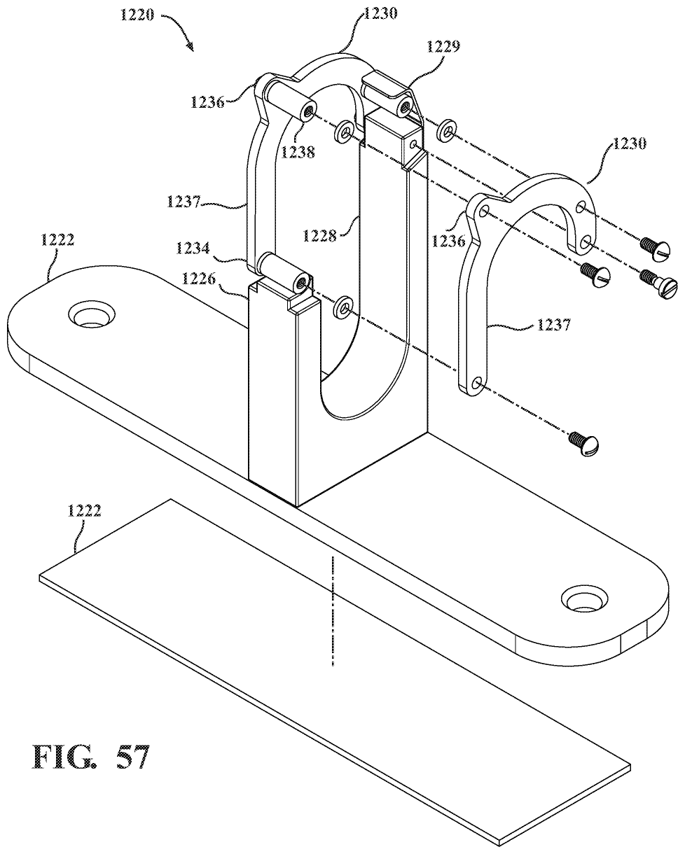

FIGS. 54-57 depict another example of a single retention member 1220. One or more of the retention members 1220 may be disposed on the support surface 1003 of the base 1002 of the anti-theft device 1000 in addition to, or in lieu of, the retention members 1020 (FIG. 44). Each retention member 1220 is operable to receive and secure one of a plurality of eyeglasses, and includes a retention base 1222 that may be disposed on the support surface 1003 of the base 1002 (FIG. 44). The retention member 1220 has a cradle 1224 attached to the retention base 1222 and a retention hook 1230 rotatably attached at a distal end of the cradle 1224. The cradle 1224 and the retention hook 1230 cooperate to define a receptacle 1216 for receiving a bridge portion of the eyeglasses 10. As shown, the cradle 1224 includes a concave bottom surface 1225 wherein an open end of the concave bottom surface 1225 faces upwards towards the retention hook 1230. The concave bottom surface 1225 automatically centers the eyeglasses 10 within the retention member 1220. The cradle 1224 may also include a first arm 1226 and a second arm 1228 spaced apart from the first arm 1226 to define the receptacle 1216. The first arm 1224 and the second arm 1228 are attached to the concave bottom surface 1225. The first arm 1226 has a socket 1227 at a distal end of the first arm 1226, and the second arm 1228 has a sixth axis A6 extending through a distal end of the second arm 1228. The first arm 1226 has a seventh length L7 and the second arm 1228 has an eighth length L8 that is greater than the seventh length L7. For example, the eighth length L8 may be twice as long as the seventh length L7. Notably, the seventh length L7 of the first arm 1226 defines a distance that the eyeglasses 10 need to move vertically to remove the eyeglasses 10 from within the retention member 1220.

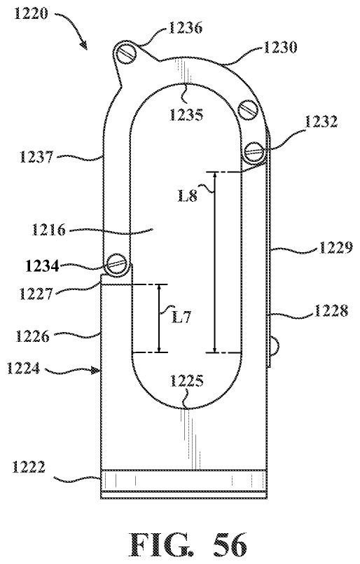

The retention hook 1230 includes a first end 1232 and a second end 1234 whereby the first end 1232 may be rotatably attached to a distal end of the second arm 1228. The retention hook 1230 includes a concave surface 1235 wherein an open end of the concave surface 1235 faces downwards. More specifically, the open end of the concave surface 1235 of the retention hook 1230 faces downwards towards the concave bottom surface 1225 of the cradle 1220 when the retention hook 1230 is in a closed configuration. The retention hook 1230 includes an extension member 1237 that connects the concave surface 1235 to the second end 1234. The extension member 1237 is substantially straight and adds additional length to the retention hook 1230 due to the seventh length L7 being less than the eighth length L8. The retention hook 1230 may also include a protrusion 1236 that extends tangentially from the retention hook 1230. That is, the protrusion 1236 extends tangentially from a location of the retention hook 1230 located between the first end 1232 and the second end 1234 of the retention hook 1230. The protrusion 1236 includes a cross member 1238 that connects a first half of the protrusion 1236 to a second half of the protrusion 1236. The protrusion 1236 provides a surface that a user may interact with (e.g., grasp) to open or close the retention hook 1230. Thus, the retention hook 1230 is operable to rotate about the sixth axis A6 between the closed configuration and an open configuration. In the closed configuration, the receptacle 1216 of the retention element 1224 and the retention hook 1230 define a closed area such that eyeglasses 10 may not be placed within, or removed from the receptacle 1216, as shown in FIG. 56. In the closed configuration, the second end 1234 of the retention hook 1230 interfaces with the socket 1227 at the distal end of the first arm 1226. On the other hand, in the open configuration, the retention element 1224 and the retention hook 1230 define an open area such that eyeglasses 10 may be placed within, or removed from, the receptacle 1216. In some examples, the retention member 1220 includes a biasing member 1229 attached to the second arm 1228 of the retention element 1224 and the first end 1232 of the retention hook 1230. As such, the biasing member 1229 biases by applying a biasing force to the retention hook 1230 to bias the retention hook 1230 in the closed configuration. In some examples, the biasing member 1229 locks the retention hook 1230 in the closed configuration.

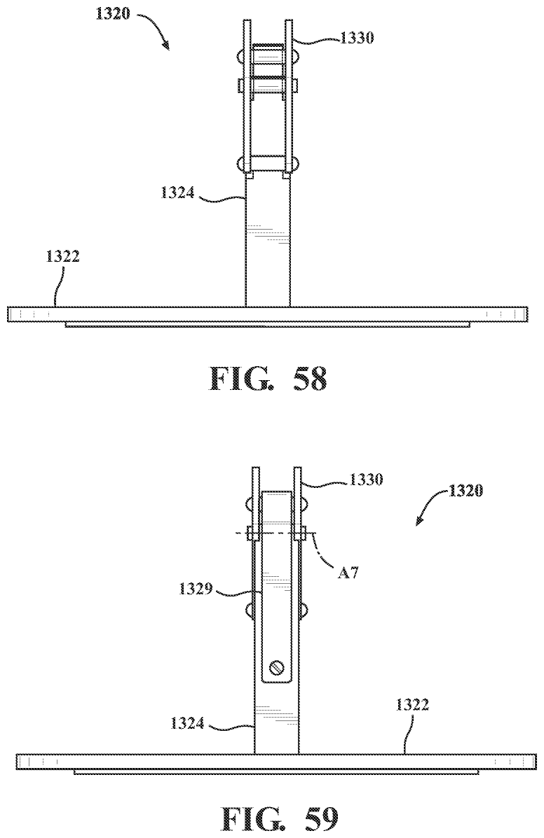

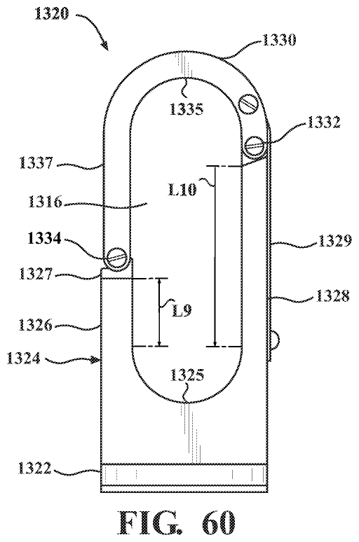

FIGS. 58-61 depict another example of a single retention member 1320. One or more of the retention members 1320 may be disposed on the support surface 1003 of the base 1002 of the anti-theft device 1000 in addition to, or in lieu of, the retention members 1020 (FIG. 44). In short, the retention member 1320 is substantially similar to the retention member 1220 (FIGS. 54-57), but the retention member 1320 does not include the protrusion 1236 nor the cross member 1238. Each retention member 1320 is operable to receive and secure one of a plurality of eyeglasses, and includes a retention base 1322 that may be disposed on the support surface 1003 of the base 1002 (FIG. 44). The retention member 1320 has a cradle 1324 attached to the retention base 1322 and a retention hook 1330 rotatably attached at a distal end of the cradle 1324. The cradle 1324 and the retention hook 1330 cooperate to define a receptacle 1316 for receiving a bridge portion of the eyeglasses 10. As shown, the cradle 1324 includes a concave bottom surface 1325 wherein an open end of the concave bottom surface 1325 faces upwards towards the retention hook 1330. The concave bottom surface 1325 automatically centers the eyeglasses 10 within the retention member 1320. The cradle 1324 may also include a first arm 1326 and a second arm 1328 spaced apart from the first arm 1326 to define the receptacle 1316. The first arm 1324 and the second arm 1328 are attached to the concave bottom surface 1325. The first arm 1326 has a socket 1327 at a distal end of the first arm 1326, and the second arm 1328 has a seventh axis A7 extending through a distal end of the second arm 1328. The first arm 1326 has a ninth length L9 and the second arm 1328 has a tenth length L10 that is greater than the ninth length L9. Notably, the ninth length L9 of the first arm 1326 defines a distance that the eyeglasses 10 need to move vertically to remove the eyeglasses 10 from within the retention member 1320.

The retention hook 1330 includes a first end 1332 and a second end 1334 whereby the first end 1332 may be rotatably attached to a distal end of the second arm 1328. The retention hook 1330 includes a concave surface 1335 wherein an open end of the concave surface 1335 faces downwards. More specifically, the open end of the concave surface 1335 of the retention hook 1330 faces downwards towards the concave bottom surface 1325 of the cradle 1320 when the retention hook 1330 is in a closed configuration. The retention hook 1230 includes an extension member 1337 that connects the concave surface 1335 to the second end 1334. The extension member 1337 is substantially straight and adds additional length to the retention hook 1330 due to the ninth length L9 being less than the tenth length L10. The retention hook 1330 may also include a protrusion 1336 that extends tangentially from the retention hook 1330. That is, the protrusion 1336 extends tangentially from a location of the retention hook 1330 located between the first end 1332 and the second end 1334 of the retention hook 1330. The protrusion 1336 includes a cross member 1338 that connects a first half of the protrusion 1336 to a second half of the protrusion 1336. The protrusion 1336 provides a surface that a user may interact with (e.g., grasp) to open or close the retention hook 1330. Thus, the retention hook 1330 is operable to rotate about the seventh axis A7 between the closed configuration and an open configuration. In the closed configuration, the receptacle 1316 of the retention element 1324 and the retention hook 1330 define a closed area such that eyeglasses 10 may not be placed within, or removed from the receptacle 1316, as shown in FIG. 56. In the closed configuration, the second end 1334 of the retention hook 1330 interfaces with the socket 1327 at the distal end of the first arm 1326. On the other hand, in the open configuration, the retention element 1324 and the retention hook 1330 define an open area such that eyeglasses 10 may be placed within, or removed from, the receptacle 1316. In some examples, the retention member 1320 includes a biasing member 1329 attached to the second arm 1328 of the retention element 1324 and the first end 1332 of the retention hook 1330. As such, the biasing member 1329 biases by applying a biasing force to the retention hook 1330 to bias the retention hook 1330 in the closed configuration. In some examples, the biasing member 1329 locks the retention hook 1330 in the closed configuration.

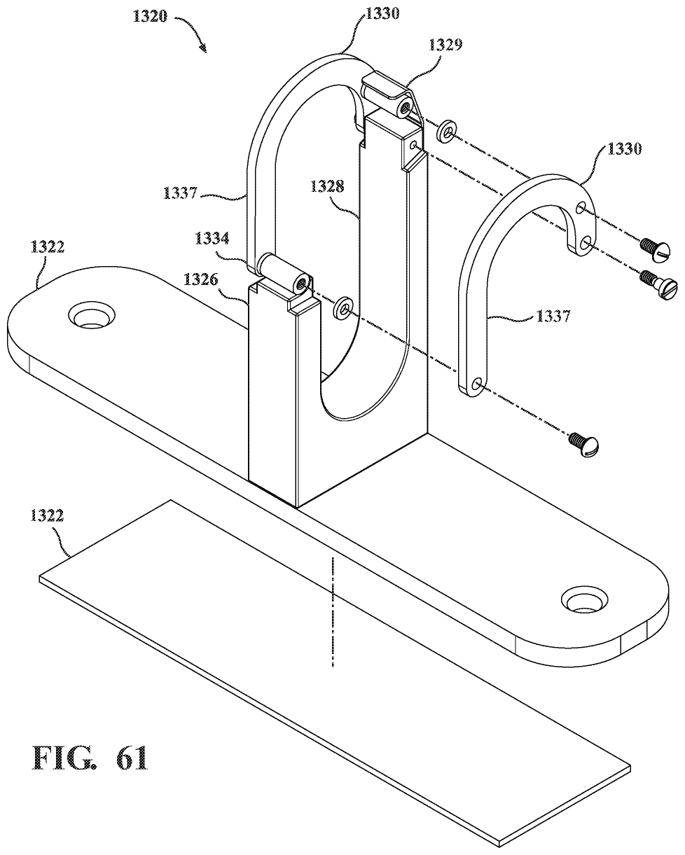

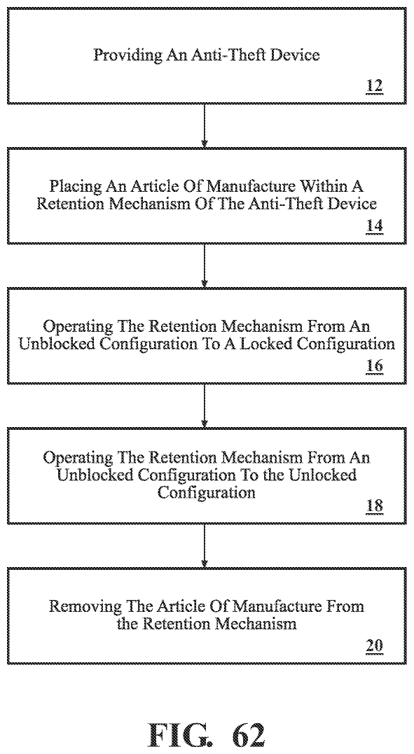

Referring now to FIG. 62, in conjunction with FIGS. 1-61, an example process flow diagram is provided, depicting a method for securing an article of manufacture via an anti-theft device. The steps delineated in the exemplary process flow diagram of FIG. 62 are merely exemplary of an example for the securing of an article. The steps may be carried out in another order, with or without additional steps included therein. Additionally, the steps may be carried out with an alternative example of the anti-theft device, as contemplated in the above description.

The method for securing an article of manufacture within an anti-theft device begins at step 12, in which the anti-theft device is provided. The anti-theft device includes the components discussed above. The method then proceeds to step 14, in which a user places an article of manufacture within the retention mechanism of the anti-theft device while the retention mechanism is in an open configuration. The method then proceeds to step 16, where the operates the retention mechanism from the open configuration to a closed configuration, thereby securing the article of manufacture within the retention mechanism. Here, the closed configuration prevents the article of manufacture from being removed from the retention mechanism. At some time thereafter, at step 18, the user operates the retention mechanism from the closed configuration to the open configuration. At step 20, the user removes the article of manufacture from the retention mechanism while the retention mechanism is in the open configuration. 150, a user operates the lock to permit the second retention rail to be translated to the open configuration.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations

What is claimed is:

1. An anti-theft device for storing eyeglasses, the anti-theft device comprising:
a frame defining a channel extending from a first end to a second end;
a first retention rail attached to the frame and including a plurality of first retention members; and
a second retention rail slidably disposed in the channel and including a plurality of second retention members, the second retention members operable to selectively engage the first retention members, wherein the frame, the first retention members, and the second retention members cooperate to define a corresponding plurality of receptacles each operable to receive one or more of the eyeglasses.

2. The anti-theft device of claim 1, wherein second retention rail is operable to translate within the channel along the translation axis between an open configuration to permit access to the receptacle and a closed configuration to prevent access to the receptacle.

3. The anti-theft device of claim 2, wherein
each of the first retention members includes a first support extending away from the first body and a first overhang extending away from the first support in a first direction; and
each of the second retention members comprises a second support extending away from the second body and a second overhang extending away from the second support in a second direction opposite the first direction.

4. The anti-theft device of claim 3, wherein:
at least a portion of each first overhang is disposed adjacent to at least a portion of a corresponding second overhang in the closed configuration; and
each first overhang is spaced apart from each corresponding second overhang in the open configuration.

5. The anti-theft device of claim 2, wherein the channel comprises a notch operable to receive a portion of the second retention rail in the open configuration.

6. The anti-theft device of claim 2, wherein the retention mechanism further comprises a locking mechanism operable to prevent the second retention rail from translating from the closed configuration to the open configuration.

7. An anti-theft device for storing eyeglasses, the anti-theft device comprising:
a base having a first end and a second end, the first end opposite the second end;
a first support member coupled to the first end of the base and including a first receiving portion;
a second support member coupled to the second end of the base and including a second receiving portion; and
a retention rod extending from the first receiving portion to the second receiving portion and configured to translate between an open configuration and a closed configuration to selectively permit access to the base.

8. The anti-theft device of claim 7, wherein the retention mechanism comprises:
a frame extending from the first end to the second end of the base, the frame operable to receive at least a bridge or nose pad of the eyeglasses.

9. The anti-theft device of claim 8, wherein, in the closed configuration, the retention rod is positioned vertically above the frame.

10. The anti-theft device of claim 8, wherein, in the open configuration, the retention rod is laterally offset from the frame.

11. The anti-theft device of claim 8, wherein, in the closed configuration, a distance between the retention rod and the frame is configured to be less than a height of a lens of a pair of eyeglasses.

12. The anti-theft device of claim 7, wherein the retention rod is capable of moving within the first receiving portion and the second receiving portion to operate between the closed configuration and the open configuration.

13. The anti-theft device of claim 7, wherein the retention rod includes a proximal end, a distal end, a first end cap attached to the proximal end, and a second end cap attached to the distal end, wherein the first end cap secures the proximal end of the retention rod within the first receiving portion and the second end cap secures the distal end of the retention rod within the second receiving portion.

14. The anti-theft device of claim 13, wherein the retention mechanism further includes a locking mechanism attached to the second support member, the locking mechanism includes an opening that surrounds a portion of the second receiving portion, wherein the locking mechanism is configured to mechanically engage the second end cap of the retention rod to secure the retention rod in the closed configuration.

15. An anti-theft device for storing eyeglasses, the anti-theft device comprising:
one or more retention members each including:
a retention base;
a cradle attached to the retention base; and
a retention hook rotatably attached to the cradle,
wherein the cradle and the retention hook cooperate to define a receptacle operable to receive one or more of the eyeglasses.

16. The anti-theft device of claim 15, wherein each retention hook is operable to rotate between an open configuration to permit access to the receptacle and a closed configuration to prevent access to the receptacle.

17. The anti-theft device of claim 16, wherein each cradle comprises a first arm having a socket at a distal end of the first arm and a second arm having a distal end.

18. The anti-theft device of claim 17, wherein each retention hook comprises a first end and a second end, wherein the first end of the retention hook is rotatably attached to the distal end of the second arm.

19. The anti-theft device of claim 18, wherein the second end of the retention hook interfaces with the socket at the distal end of the first arm in the closed configuration.

20. The anti-theft device of claim 15, wherein each retention member further comprises a biasing feature biasing the retention hook in a closed configuration.
